(19) United States
(12) Patent Application Publication
(10) Pub. No.: US 2023/0415252 A1
(43) Pub. Date: Dec. 28, 2023

(54) ELECTRICAL DISCHARGE MACHINING APPARATUS

(71) Applicant: HIGHLIGHT TECH CORP., Tainan City (TW)

(72) Inventors: CHWUNG-SHAN KOU, Tainan City (TW); WEN-YUNG YEH, Tainan City (TW); CHANG-YING CHEN, Tainan City (TW)

(73) Assignee: HIGHLIGHT TECH CORP., Tainan City (TW)

(21) Appl. No.: 18/210,683

(22) Filed: Jun. 16, 2023

Related U.S. Application Data
(60) Provisional application No. 63/355,107, filed on Jun. 24, 2022.

(30) Foreign Application Priority Data
Sep. 30, 2022 (TW) 111137349
Apr. 19, 2023 (TW) 112114524

(51) Int. Cl. B23H 11/00; B23H 7/14; B23H 7/26

(52) U.S. Cl. CPC B23H 11/003; B23H 7/14; B23H 7/26

(57) ABSTRACT

Disclosed is an electrical discharge machining apparatus at least comprising a carrier platform and an electrical discharge machining unit. The carrier platform is used to carry at least one to-be-machined object. The electrical discharge machining unit comprises an electrode, a jig and a power supply unit. When the electrical discharge machining unit performs an electrical discharge machining procedure on a machined target area of the to-be-machined object along a machining direction, an electrical discharge section of the electrode and the machined target area of the to-be-machined object move relatively. The invention is capable of improving a machining procedure, saving an overall machining time and saving a time required for electrode replacement.

### CROSS-REFERENCE TO RELATED APPLICATION

This application claims priority to U.S. Provisional Patent Application No. 63/355,107, filed on Jun. 24, 2022; claims priority from Taiwan Patent Application No. 111137349, filed on Sep. 30, 2022; and claims priority from Taiwan Patent Application No. 112114524, filed on Apr. 19, 2023, each of which is hereby incorporated herein by reference in its entireties.

### BACKGROUND OF THE INVENTION

### 1. Field of Invention

The invention relates to a machining apparatus, and more particularly to an electrical discharge machining apparatus.

### 2. Related Art

With the booming semiconductor industry, electrical discharge machining technology has been commonly used to machine ingots or wafers. Electrical discharge machining (EDM) is a manufacturing process wherein sparks are generated by electrical discharges thereby a desired shape of a to-be-machined object can be obtained. A dielectric material separates two electrodes and a voltage is applied to generate rapidly recurring current discharges between the two electrodes to machine the to-be-machined object. Electrical discharge machining technology uses two electrodes, one of which is called the tool electrode, or the discharge electrode, while the other is called the workpiece electrode, connected to the to-be-machined object. During electrical discharge machining, there is no physical contact between the discharge electrode and the workpiece electrode.

When the potential difference between the two electrodes is increased, the electric field between the two electrodes becomes greater until the intensity of the electric field exceeds the dielectric strength, causing dielectric breakdown, current flows through the two electrodes, and part of the material is removed. Once the current stops, new dielectric material is conveyed into the inter-electrode electric field, enabling the partial material to be carried away and restoring the dielectric insulating effect. After a current flow, the potential difference between the two electrodes is restored to what it was before the dielectric break down, so that a new dielectric breakdown can occur to repeat the cycle.

However, the disadvantage of the current electrical discharge machining technology is that the roughness of the cut surface is not good, and there are quite a few surface cracks on the cut surface, which even extend along the non-cut direction, resulting in cracking effect in an unexpected direction. Moreover, in the existing electrical discharge machining technology, for example, when cutting an ingot, a jig is used to clamp a periphery of the ingot, that is, the side edge of the ingot is radially clamped to prevent scrolling or displacement. However, since the cut surface of the ingot is also located in the radial direction, the conventional technology can only cut the ingot exposed on the outer side of the jig, and cannot cut the area where the jig and the ingot overlap, so in the conventional technology, the machine or apparatus needs to be shut down to readjust a position to enable cutting again. In addition, the existing electrical discharge machining technology can only cut or thin one wafer at a time, which is quite slow in machining. Furthermore, the existing electrical discharge machining technology only uses a single cutting wire, and the existing electrical discharge machining apparatuses do not have a quick-disassemble design, if the cutting wire breaks accidentally, the electrical discharge machining apparatus needs to be shut down and it takes a lot of time to complete replacement.

### SUMMARY OF THE INVENTION

In view of the above, one object of the invention is to provide an electrical discharge machining apparatus to solve the above-mentioned problems of the prior art.

In order to achieve the aforementioned object, the invention provides an electrical discharge machining apparatus at least comprising: a carrier platform for carrying at least one to-be-machined object; and an electrical discharge machining unit for performing an electrical discharge machining procedure on a machined target area of the to-be-machined object on the carrier platform along a machining direction, the electrical discharge machining unit comprises: at least one electrode; a jig, the jig is formed by correspondingly assembling at least two carrying members and at least two holding members respectively, two sides of the electrodes abut against the two carrying members respectively, so that an electrical discharge section of the electrode is suspended, wherein the electrical discharge section of the electrode extends along a second direction perpendicular to a first direction; and a power supply unit, the power supply unit provides a first power source to the electrode and the to-be-machined object in the electrical discharge machining procedure for applying an electrical discharge energy to the machined target area of the to-be-machined object through the electrical discharge section of the electrode, wherein when the electrical discharge machining unit performs the electrical discharge machining procedure along the machining direction, the electrical discharge section of the electrode and the machined target area of the to-be-machined object move relatively along the second direction.

Preferably, the electrical discharge section of the electrode and the machined target area of the to-be-machined object move relative to each other along the second direction in a reciprocating or cyclical manner.

Preferably, the two carrying members and the two holding members move reciprocatingly or cyclically with the electrode, so that the electrical discharge section of the electrode applies the electrical discharge energy to the to-be-machined object.

Preferably, the electrical discharge machining unit adjusts a tension value of the electrode by causing relative displacements of the two carrying members or the two holding members.

Preferably, the electrical discharge machining apparatus further comprises a stabilizing member for stabilizing a movement of the electrode relative to the to-be-machined object.

Preferably, the electrode is in a linear shape or in a plate shape.

Preferably, the carrier platform moves along the first direction, the second direction, or the machining direction.

Preferably, the carrier platform rotates around the first direction, the second direction or the machining direction as an axis.

Preferably, the electrical discharge machining apparatus further comprises a slag removal unit, when the electrical discharge machining unit performs the electrical discharge machining procedure on the to-be-machined object, the slag removal unit provides an external force to remove residues generated by the electrical discharge energy applied by the electrode to the to-be-machined object.

Preferably, an applied direction or an applied position of the external force provided by the slag removal unit is dynamically adjusted to remove residues according to a shape of the to-be-machined object.

Preferably, the electrical discharge machining apparatus further comprises a tension measuring unit for measuring a tension value of the electrode.

Preferably, the electrical discharge machining apparatus further comprises a vibration measuring unit for measuring a vibration value of the electrode.

Preferably, the power supply unit of the electrical discharge machining unit further provides a second power source to the electrode in order to provide a direct-current power supply or a radio frequency to the electrode.

Preferably, the carrier platform further comprises a clamping element for fixing the to-be-machined object.

Preferably, the to-be-machined object has a planar area, and is connected to the carrier platform or the clamping element through the planar area.

Preferably, a shape of the clamping element is attached along a shape of the to-be-machined object.

Preferably, the clamping element has a plate body, and the plate body has a comb-like structure.

Preferably, the carrier platform has a comb-like structure.

Preferably, the carrier platform is connected to the clamping element through a lock-in structure.

Preferably, two plate bodies of the clamping element are connected to each other through a snap-fit structure.

Preferably, the clamping element has two or more than two contact surfaces with the to-be-machined object.

Preferably, the carrier platform or the clamping element is connected to the to-be-machined object by an adhesive layer.

Preferably, the adhesive layer is discontinuously disposed on the carrier platform or the clamping element.

Preferably, the adhesive layer is a conductive adhesive.

Preferably, the clamping element axially abuts against one side of the to-be-machined object, and two groove walls of a machining groove formed by the electrical discharge energy in the machined target area of the to-be-machined object are bonded by an adhesive layer.

Preferably, the electrical discharge machining unit performs the electrical discharge machining procedure on the to-be-machined object on the carrier platform and the clamping element along the machining direction.

Preferably, the clamping element clamps a buffer member, the buffer member fixes the to-be-machined object through a conductive adhesive layer, and the electrical discharge machining unit performs the electrical discharge machining procedure on the to-be-machined object on the carrier platform along the machining direction.

Preferably, the clamping element fixes the to-be-machined object by clamping a conductive frame, and the electrical discharge machining unit performs the electrical discharge machining procedure on the to-be-machined object on the carrier platform along the machining direction.

Preferably, the carrier platform, the clamping element or the to-be-machined object further has a conductive gain layer to improve an electrical contact between the to-be-machined object and the carrier platform or the to-be-machined object and the clamping element.

Preferably, the electrical discharge machining apparatus further comprises a heat supply source for providing a heat source to the to-be-machined object before, during or after performing the electrical discharge machining procedure.

Preferably, the two carrying members are respectively a plate structure or a sleeve structure.

Preferably, the two carrying members respectively comprise a first sheet and a second sheet, and the electrode is clamped between the first sheet and the second sheet.

Preferably, the two carrying members respectively have a through groove, the two holding members respectively have a protrusion corresponding to the through groove, and the two carrying members are assembled with the protrusions of the two holding members correspondingly through the through grooves.

Preferably, the two carrying members respectively have a through hole, the two holding members respectively have a screw hole, wherein the two carrying members are screwed with the screw holes of the two holding members by passing a bolt through each of the through holes.

Preferably, the two holding members respectively have a groove structure, and the two carrying members are inserted into the groove structures of the two holding members to be correspondingly assembled on the two holding members.

Preferably, the two holding members respectively have a conductive structure to electrically connect with the electrode abutting against the two carrying members.

Preferably, the two holding members fix the two carrying members and the electrode simultaneously.

Preferably, the electrical discharge machining unit further comprises an attachment member, and attachment member is connected to the electrode at an edge of the two carrying members.

Preferably, the attachment member is electrically connected to the first power source or a second power source of the power supply unit.

Preferably, head and tail ends of the electrode are respectively connected to the same carrying member or the two carrying members.

Preferably, edges of the two carrying members have lead angles.

Preferably, the to-be-machined object carried by the carrier platform is a semiconductor ingot or wafer.

Preferably, the electrical discharge machining apparatus cuts or grinds the to-be-machined object carried by the carrier platform sequentially or simultaneously during the electrical discharge machining procedure.

Preferably, the to-be-machined object is formed by electrically bonding a plurality of workpieces.

Preferably, the electrical discharge energy forms a machining groove in the machined target area of the to-be-machined object, and a filling material is filled in the machining groove.

Preferably, the electrical discharge energy forms a machining groove in the machined target area of the to-be-machined object, and the to-be-machined object is pasted with an adhesive tape on two sides of the machining groove to reduce a chattering phenomenon of the machined target area of the to-be-machined object.

Preferably, the electrical discharge machining procedure applies the electrical discharge energy to the machined target area of the to-be-machined object in a fluid.

Preferably, the fluid contains ozone or oxygen.

Preferably, the fluid contains air bubbles.

Preferably, the air bubbles are imploded by an internal and external pressure difference during the electrical discharge machining procedure.

Preferably, the air bubbles contain ozone or oxygen.

Preferably, the fluid is an electrolyte.

Preferably, the electrical discharge machining procedure applies the electrical discharge energy to the machined target area of the to-be-machined object in a vacuum environment.

Preferably, the electrical discharge machining apparatus further comprises an ultrasonic generator or a piezoelectric oscillator to vibrate the carrier platform, the to-be-machined object or the electrode.

Preferably, the electrical discharge machining apparatus further comprises an ultrasonic generator or a piezoelectric oscillator to vibrate the carrier platform, the to-be-machined object, the electrode or the fluid.

Preferably, a quantity of the electrode is multiple, and the electrodes are arranged in parallel along the first direction.

Preferably, the electrical discharge machining apparatus further comprises an orientation correction element for adjusting a relative orientation of the electrode and the to-be-machined object to correct the machining direction when a deviation phenomenon occurring in the machining direction of the electrode.

In summary, the electrical discharge machining apparatus according to the invention has the following advantages:

(1) The jig is formed by correspondingly assembling the at least two carrying members and the at least two holding members respectively, a quick-release design is capable of greatly reducing a time required for electrode replacement, and is also capable of adjusting a tension of the electrical discharge electrode.

(2) A slag removal unit is capable of providing an external force for one machined target area or more than one machined target areas, and an applied direction or an applied position of the external force is dynamically adjusted according to changes of a shape of the to-be-machined object to help eliminate residues generated by the electrical discharge machining procedure.

(3) A clamping element has a variety of clamping modes, a comb-like structure is capable of firmly clamping the to-be-machined object, which can effectively solve the problem that the conventional electrical discharge machining apparatus technology is incapable of cutting an overlapping area between the clamping element and the to-be-machined object, and a lock-in structure is further capable of achieving efficacies of disassembly and adjustment.

(4) An orientation correction element is capable of correcting the machining direction of the electrode and the to-be-machined object, thereby avoiding deviation of the machining direction.

(5) The comb-like structure formed by the clamping element or the carrier platform is conducive to the electrical discharge machining procedure and correspondingly avoiding damage.

(6) A stabilizing member is capable of reducing chattering of the electrode, serving as a separation column to provide a guiding effect, and serving as an electrical contact.

(7) A heat source is capable of reducing unwanted cracks or crack expansion caused by thermal shock, and further capable of forming a positive cycle to facilitate the electrical discharge machining procedure.

(8) A conductive gain layer is capable of improving an electrical contact between the to-be-machined object and the clamping element or the carrier platform.

(9) An adhesive layer is capable of avoiding chattering phenomenon of the to-be-machined object during the electrical discharge machining procedure, and avoiding burr phenomenon before an end of the electrical discharge machining procedure, and a conductive adhesive layer is further capable of providing an electrical contact between the to-be-machined object and the clamping element or the carrier platform.

In order to enable the examiner to have a further understanding and recognition of the technical features of the invention and the technical efficacies that can be achieved, preferred embodiments in conjunction with detailed explanation are provided as follows.

### BRIEF DESCRIPTION OF THE DRAWINGS

FIGS. 1A-1B are front views of implementation modes of an electrical discharge machining apparatus of the invention, wherein FIGS. 1A and 1B are different implementation modes.

FIGS. 2A-2C are top views of implementation modes of partial structures of the electrical discharge machining apparatus of the invention, wherein FIGS. 2A, 2B and 2C are different implementation modes.

FIGS. 3A-3B are side views of implementation modes of partial structures of the electrical discharge machining apparatus of the invention, wherein FIGS. 3A and 3B are different implementation modes.

FIG. 4 is a side view of an implementation mode of to-be-machined objects of the invention composed of a plurality of connected to-be-machined workpieces.

FIG. 5 is a top view of an implementation mode of an electrical discharge machining unit of the invention performing an electrical discharge machining procedure on multiple to-be-machined objects.

FIG. 6 is a schematic diagram of an implementation mode of electrodes of the invention with transverse cross-sections in different shapes.

FIG. 7 is a side view of an implementation mode of a head end and a tail end of the electrode of the invention respectively connected to different carrying members.

FIG. 8 is a top view of an implementation mode of the head ends and the tail ends of the electrodes of the invention respectively connected to the different carrying members.

FIGS. 9A-9C are schematic diagrams of different implementation modes of a filling material filled in machining grooves of the invention, wherein FIGS. 9A, 9B and 9C are different implementation modes.

FIGS. 10A and 10B are schematic diagrams of two implementation modes of the electrical discharge machining apparatus of the invention with a stabilizing member, wherein FIGS. 10A and 10B are different implementation modes.

FIG. 11 is a schematic diagram of an implementation mode of multiple electrodes disposed in limiting grooves of the carrying members of the invention.

FIG. 12 is a side view of an implementation mode of the carrying members of the invention with a plate-shaped structure.

FIG. 13 is a top view of an implementation mode of another plate-shaped structure of the carrying members of the invention.

FIG. 14 is a side view of an implementation mode of multiple carrying members of the invention screwed to holding members.

FIG. 15 is a side view of an implementation mode of the holding members of the invention assembled with the carrying members by groove structures.

FIG. 16 is a top view of an implementation mode of the holding members of the invention having conductive structures connected to the electrodes.

FIG. 17 is a top view of an implementation mode of insulating structures disposed between the conductive structures and the electrodes in FIG. 16.

FIGS. 18A-18B are schematic diagrams of an implementation mode of a clamping element of the invention radially clamping the to-be-machined object, wherein FIG. 18A is a side view, and FIG. 18B is a top view.

FIGS. 19A-19B are side views of the implementation modes of the clamping element of the invention axially clamping the to-be-machined object, wherein FIGS. 19A and 19B are different implementation modes.

FIG. 20 is a side view of an implementation mode of a plate body of the clamping element of the invention fixing the to-be-machined object on one side.

FIGS. 21A-21D are side views of the implementation modes of the clamping element of the invention radially clamping the to-be-machined object, wherein FIGS. 21A, 21B, 21C and 21D are different implementation modes.

FIGS. 22A-22C are side views of the implementation modes of improving electrical contact through a conductive gain layer of the invention, wherein FIGS. 22A, 22B and 22C are different implementation modes.

FIGS. 23A-23C are side views of the implementation modes of the invention using a comb-like structure to assist the electrical discharge machining procedure, wherein FIGS. 23A, 23B and 23C are different implementation modes.

FIGS. 24A-24B are side views of an implementation mode of the invention detachably disposing the clamping element through a lock-in structure, wherein FIGS. 24A and 24B are schematic diagrams obtained from different viewing angles.

FIGS. 25A-25B are side views of an implementation mode of the invention detachably disposing the clamping element through the lock-in structure and a snap-fit structure, wherein FIGS. 25A and 25B are schematic diagrams obtained from different viewing angles.

FIGS. 26A-26D are schematic diagrams of the implementation modes of the electrical discharge machining apparatus of the invention clamping the to-be-machined object, wherein FIGS. 26A to 26D are different implementation modes.

FIGS. 27A-27B are schematic diagrams of the implementation modes of the invention using the carrying members to arrange the electrodes in parallel to one another, wherein FIG. 27A shows the electrodes arranged in parallel to one another along a machining direction F (that is, multiples electrodes sequentially perform the electrical discharge machining procedure on a single machined target area), and FIG. 27B shows the electrodes arranged in parallel to one another along a first direction X (that is, multiples electrodes perform the electrical discharge machining procedure on multiples machined target areas simultaneously).

FIGS. 28A-28B are top views of the implementation modes of the invention using separation columns to make the electrodes parallel to one another, wherein FIG. 28A is a schematic diagram of the electrodes surrounding the carrying members on two sides, and FIG. 28B is a schematic diagram of the electrodes connecting the carrying members on two sides.

FIGS. 29A-29B are views of implementation modes of the electrical discharge machining apparatus of the invention provided with a slag removal unit, wherein FIGS. 29A and 29B are schematic diagrams of different implementation modes.

FIG. 30 is a schematic diagram of an implementation mode of two jigs of the electrical discharge machining apparatus of the invention scrolling the electrode.

FIG. 31 is a schematic diagram of an implementation mode of the electrical discharge machining apparatus of the invention provided with a tension control module.

FIG. 32 is a schematic diagram of an implementation mode of the electrical discharge machining apparatus of the invention provided with an orientation correction element.

### DETAILED DESCRIPTION OF THE INVENTION

In order to understand the technical features, content and advantages of the invention and its achievable efficacies, the invention is described below in detail in conjunction with the figures, and in the form of embodiments, the figures used herein are only for a purpose of schematically supplementing the specification, and may not be true proportions and precise configurations after implementation of the invention; and therefore, relationship between the proportions and configurations of the attached figures should not be interpreted to limit the scope of the claims of the invention in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present invention will be defined below or in other parts of the descriptions as an extra guidance for those skilled in the art to understand the descriptions of the present invention.

The terms such as “first”, “second”, “third” used in the descriptions are not indicating an order or sequence, and are not intending to limit the scope of the present invention. They are used only for differentiation of components or operations described by the same terms.

Moreover, the terms “comprising”, “including”, “having”, and “with” used in the descriptions are all open terms and have the meaning of “comprising but not limited to”.

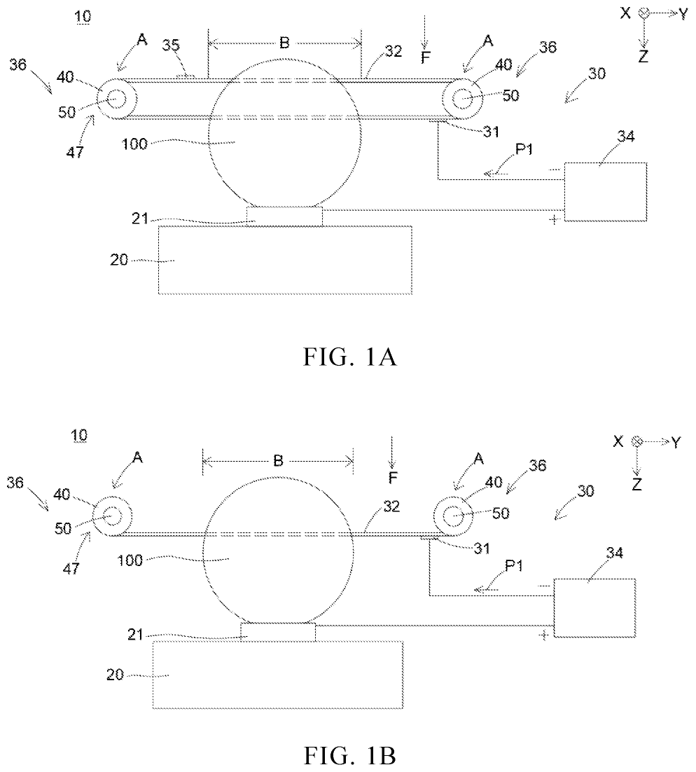

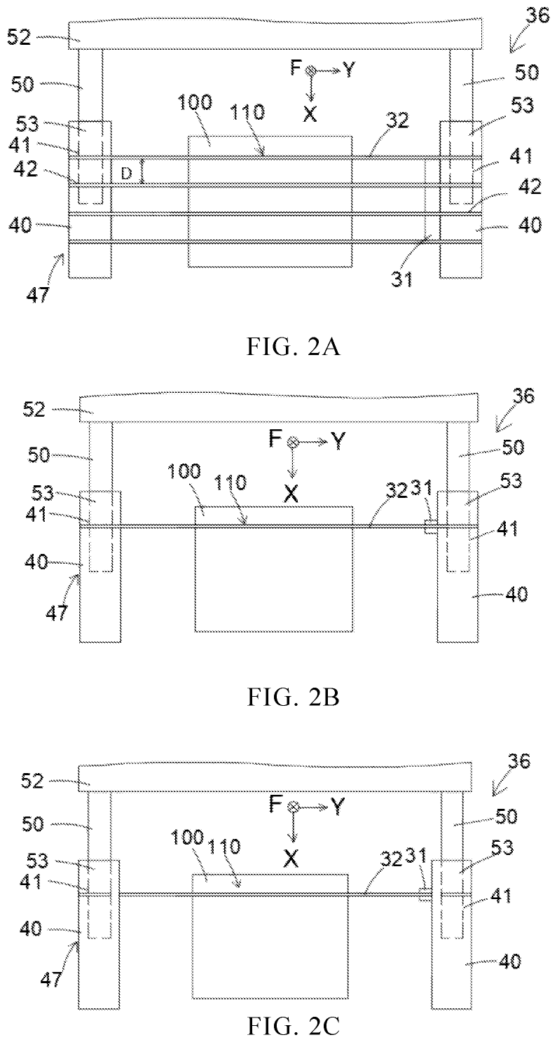

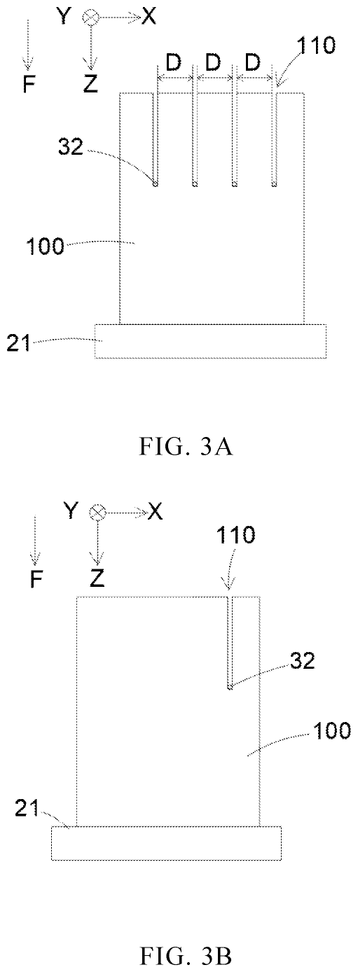

FIGS. 1A-1B are front views of an electrical discharge machining apparatus of the invention, wherein the electrode in a surrounding design (i.e., encircle design) is shown in FIG. 1A, and the electrode in a bridging design (i.e., interconnect design) is shown in FIG. 1B. FIGS. 2A-2B are top views of partial structures of the electrical discharge machining apparatus of the invention, wherein multiple electrodes in a surrounding design are shown in FIG. 2A, single electrode in a surrounding design is shown in FIG. 2B, and single electrode in a bridging design is shown in FIG. 2C. FIGS. 3A-3B are side views of partial structures of the electrical discharge machining apparatus of the invention, wherein FIG. 3A shows multiple electrodes performing the electrical discharge machining procedure on multiple machined target areas simultaneously, and FIG. 3B shows single electrode performing the electrical discharge machining procedure on single machined target area. Please refer to FIGS. 1A-1B to FIGS. 3A-3B, an electrical discharge machining apparatus 10 of the invention at least comprises a carrier platform 20 and an electrical discharge machining unit 30. The carrier platform 20 is used to carry at least one to-be-machined object 100. Two ends of an electrode 32 are respectively bridged (as shown in FIG. 1B and FIG. 2C) or the two ends of the electrodes 32 are respectively surrounded (as shown in FIG. 1A, FIG. 2A, and FIG. 2B) on two jigs 36 to cause an electrical discharge section B of the electrode 32 suspended. The electrode 32 of the electrical discharge machining unit 30 extends along a second direction Y, so that the electrical discharge section B of the electrode 32 is parallel to the second direction Y, wherein the second direction Y is perpendicular to a first direction X and a machining direction F respectively. The electrical discharge section B of the electrode 32 and a machined target area 110 of the to-be machined object 100 move relative to each other in a reciprocating or cyclical manner (for example, a relative displacement is generated along the second direction Y shown in FIGS. 1A-1B) for performing the electrical discharge machining procedure on the machined target area 110 of the to-be-machined object 100 on the carrier platform 20 by the electrode 32 along the machining direction F. A power supply unit 34 of the electrical discharge machining unit 30 provides a first power source P1 to the electrode 32 and the to-be-machined object 100 during the electrical discharge machining procedure in order to apply an electrical discharge energy to the machined target area 110 of the to-be-machined object 100 through the electrode 32 located in the electrical discharge section B.

The to-be-machined object 100 can be any conductor or semiconductor structure, such as an ingot or a wafer, and its shape can be, for example, a cylindrical block or a sheet. The to-be-machined object 100 is defined with at least one machined target area 110, such as single machined target area 110 (as shown in FIG. 3B) or multiple machined target areas 110 (as shown in FIG. 3A). Taking multiple machined target areas 110 as an example, the machined target areas 110 are arranged in parallel at any position suitable for machining in the to-be-machined object 100. A distance D between the machined target areas 110 corresponds to (for example, the same as) cutting thickness, thinning thickness or cutting distance of the to-be-machined object 100, and its numerical value can be optionally adjusted according to actual process requirements, so it is not limited to being equal or unequal.

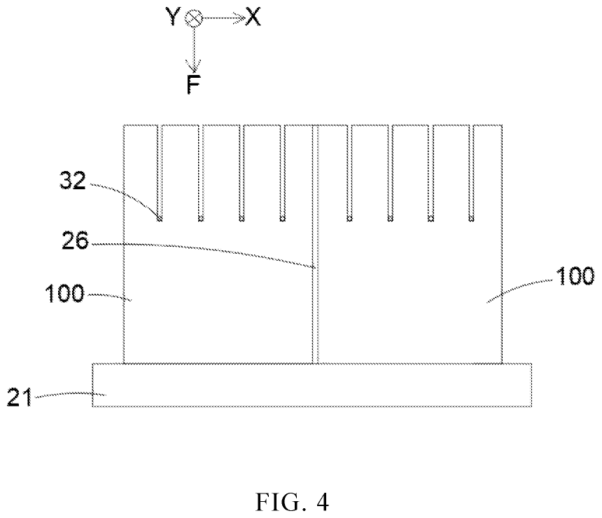

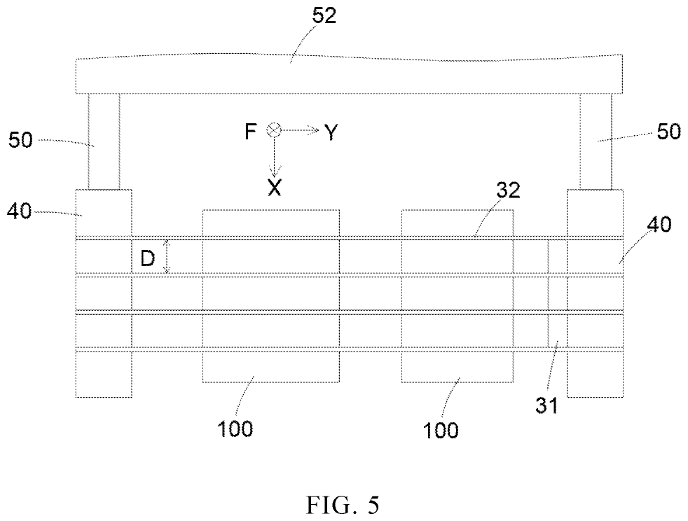

As shown in FIGS. 1A-1B to 3A-3B, the electrical discharge machining unit 30 is used to perform the electrical discharge machining procedure on the machined target area 110 of the to-be-machined object 100 on the carrier platform 20 along the machining direction F, for example, the machined target areas 110 of the to-be-machined object 100 are sequentially or simultaneously subjected to cutting and/or electrical discharge grinding (EDG). The invention is not limited to the carrier platform 20 driving the to-be-machined object 100 to move toward the electrode 32 of the electrical discharge machining unit 30 or the electrical discharge machining unit 30 driving the electrode 32 to move toward the to-be-machined object 100, as long as the electrical discharge machining unit 30 and the to-be-machined object 100 on the carrier platform 20 are capable of performing relative movements along the machining direction F, it is applicable to the invention. In other words, the carrier platform 20 of the invention can be a fixed-position carrier platform, or a movable or rotatable motional carrier platform, wherein the invention is illustrated by taking the carrier platform 20 as a working platform with a carrier plate 21, but the invention is not limited thereto, the carrier platform 20 of the invention can also optionally omit the carrier plate 21 or replace the carrier plate 21 with an adhesive layer which will be described hereinafter. By the same token, the to-be-machined object 100 of the invention is not limited to being composed of single workpiece, the to-be-machined object 100 of the invention can also be composed of a plurality of connected workpieces, for example, wherein the workpieces can be optionally connected with one another by an adhesive layer 26, for example (as shown in an implementation example in FIG. 4), wherein the adhesive layer 26 is, for example, a conductive glue capable of facilitating electrical contact. However, the invention is not limited thereto, as long as the adhesive layer 26 described above or later is capable of exerting an adhesive effect, no matter whether the adhesive layer 26 is conductive or not, it belongs to a scope of protection claimed by the invention. In addition, the electrical discharge machining unit 30 of the invention is also capable of optionally performing the electrical discharge machining procedure on single to-be-machined object 100 or multiple to-be-machined objects 100 sequentially or simultaneously (as shown in FIG. 5). Wherein FIG. 4 is a side view of multiple to-be-machined objects 100 connected to each other to perform the electrical discharge machining procedure, and FIG. 5 is a top view of the electrical discharge machining apparatus 10 of the invention performing the electrical discharge machining procedure on multiple to-be-machined objects 100.

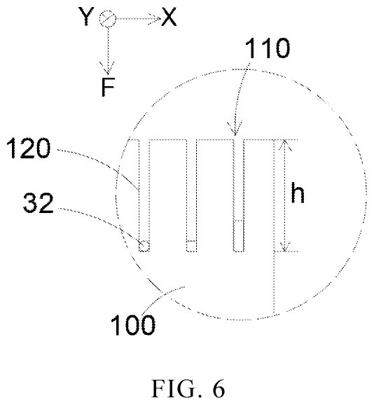

As shown in FIGS. 1A-1B to 3A-3B, the electrical discharge machining unit 30 comprises the at least one electrode 32, the power supply unit 34 and the jig 36. A quantity of the at least one electrode 32 can be, for example, one (as shown in FIG. 2B, FIG. 2C and FIG. 3B) or more than one, which is/are used to perform the electrical discharge machining procedure on single machined target area 110 or multiple machined target areas 110 (as shown in FIG. 2A and FIG. 3A) defined on the to-be-machined object 100. Taking multiple electrodes 32 in the electrical discharge sections B extending along the second direction Y as an example, the electrodes 32 are linear shaped (or strip) or plate-shaped (or sheet) conductive structures parallel to one another along the first direction X and/or along the machining direction F, such as conductive wires or foil. A quantity of the electrodes 32 is optionally determined according to actual requirements. The distance D between the electrodes 32 in the first direction X corresponds to cutting or thinning thickness of the to-be-machined object 100. Transverse cross-sections of the electrodes 32 can be any shapes that are the same or different, such as linear or plate-shape, or any symmetrical (such as circular, square, or rectangular shown in FIG. 6) or asymmetrical shapes. The power supply unit 34 is electrically connected to the electrodes 32 and the to-be-machined object 100 respectively via electrical contacts 31. Wherein the power supply unit 34 can be single power output or a plurality of power outputs for supplying the first power source P1. The power supply unit 34 can also be electrically connected to the electrodes 32 in series or in parallel, as long as an electrical discharge energy is applicable to the machined target area 110 of the to-be-machined object 100 through the electrodes 32, it is applicable to the invention. A material of the electrodes 32, for example, can be selected from a group consisting of copper, brass, molybdenum, tungsten, graphite, steel, aluminum and zinc. A thickness of the electrical discharge electrodes 32 is approximately less than 300 μm, and a thickness range is preferably approximately 30 μm to approximately 300 μm. However, it should be noted that although the invention is illustrated with multiple electrodes 32, it is not limited thereto. Single electrode 32, as shown in FIG. 2B, FIG. 2C and FIG. 3B, also belongs to a scope of protection claimed by the invention. Since a person having ordinary skill in the art to which the invention pertains should understand how to apply the technical means of the invention to a single electrode or a plurality of electrodes based on the disclosure of the invention and the conventional techniques, no further details are provided herein.

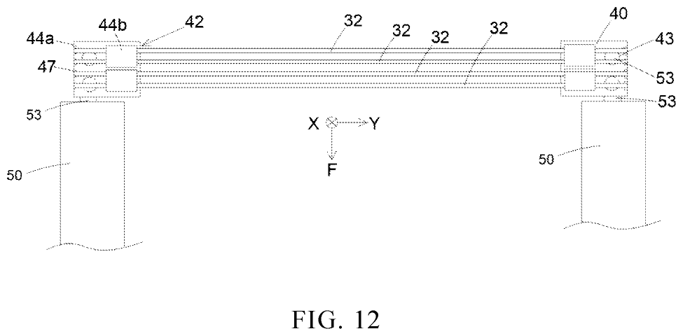

Please refer to FIGS. 1A-1B to 3A-3B, the jig 36 is formed by correspondingly assembling at least two carrying members 40 and at least two holding members 50 respectively. Two sides A of the electrode 32 movably or fixedly abut against the two carrying members 40 respectively, so that the electrical discharge section B of the electrode 32 is suspended, wherein the two carrying members 40 are separated from each other by a distance. Dimensions of the two carrying members and a height of the electrode 32 the two carrying members 40 carry are not particularly limited to be the same or different, as long as the electrical discharge section B of the electrode 32 can be suspended, it is applicable to the invention. The holding member 50 is optionally detachably or fixedly assembling with the carrying member 40 stably. The holding member 50 is disposed on a seat body 52, wherein the seat body 52 can be a structure that is capable of fixing a position of the holding member 50, or the seat body 52 is a motion mechanism capable of moving or rotating the holding member 50 to correspondingly drive the carrying member 40 to move or rotate. Therefore, the electrical discharge section B of the electrode 32 is capable of reciprocating leftward and rightward. Taking the seat body 52 as a motion mechanism as an example, the motion mechanism can be any moving mechanism capable of reciprocating leftward and rightward, such as a sliding mechanism, or any rotating mechanism capable of performing reciprocating rotation or cyclical rotation, such as a motor, used to correspondingly drive the holding member 50 to move or rotate. Thereby, the carrying member 40 and the holding member 50 are capable of optionally moving reciprocatingly or cyclically together with the electrode 32, so that the electrode 32 is capable of applying an electrical discharge energy to the to-be-machined object 100 in the electrical discharge section B. In order to enable the electrode 32 to have better adherence to the carrying member 40, an edge of the carrying member 40 is optionally provided with a lead angle 47, as shown in FIGS. 2A-2C and FIG. 12.

In the electrical discharge machining procedure, the power supply unit 34 provides the first power source P1 to the electrode 32 and the to-be-machined object 100 in order to apply an electrical discharge energy to the machined target area 110 of the to-be-machined object 100 through the electrical discharge section B of the electrode 32, wherein when the electrical discharge machining unit 30 carries out the electrical discharge machining procedure on the machined target area 110 of the to-be-machined object 100 along the machining direction F (cutting/grinding direction), the electrical discharge section B of the electrode 32 and the machined target area 110 of the to-be-machined object 100 move relatively along the second direction Y, such as a reciprocating or cyclical relative movement. That is, either the electrode 32 or the to-be-machined object 100 is fixed, while the other moves relatively. Alternatively, both the electrode 32 and the to-be-machined object 100 move relatively. Wherein the machining direction F can be, for example, perpendicular to the first direction X or the second direction Y, or inclined to the first direction X or the second direction Y. For example, taking the to-be-machined object 100 moving relative to the electrode 32 as an example, the carrier platform 20 of the invention is, for example, a movable or rotatable motional carrier platform, and for example, moves along the first direction X, the second direction Y or the machining direction F, or rotates around the first direction X, the second direction Y or the machining direction F as an axis.

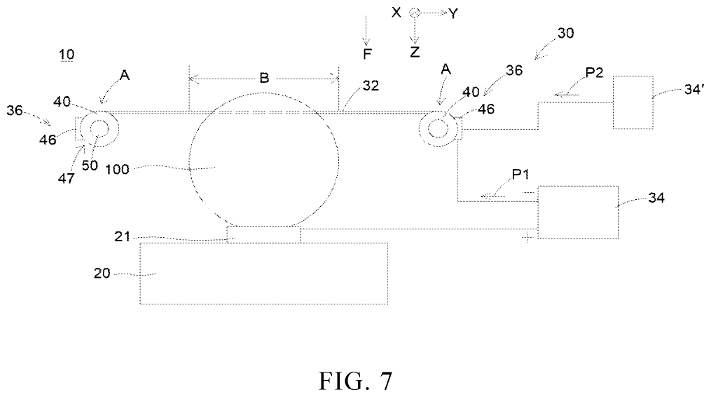

In the invention, as shown in FIGS. 1A-1B to 3A-3B, the electrodes 32 arranged in parallel along the first direction X can be, for example, spaced apart from one another and movably surrounding the two carrying members 40, so that the electrical discharge section B of the electrode 32 is in a suspended state, and is capable of moving reciprocatingly or cyclically along the second direction Y along with movements of the two carrying members 40. Alternatively, the electrodes 32 can be, for example, fixedly bridging or spaced apart from one another and movably surrounding the two carrying members 40. The electrical discharge machining apparatus 10 optionally has a connection structure 35, and the connection structure 35 extends along the first direction X to connect with multiple electrodes 32 arranged in parallel along the first direction X. The connection structure 35 is capable of increasing a structural stability of the electrical discharge electrode 32 during the electrical discharge machining procedure, so the connection structure 35 can be made of a non-conductive material to prevent multiple electrodes 32 from electrically contacting one another. If the connection structure 35 is made of a conductive material, then the connection structure 35 can be used as the electrical contact 31. That is, head and tail ends of each of the electrodes 32 are respectively connected to the same carrying member 40 (as shown in FIG. 1A) or the different carrying members 40 (as shown in FIG. 7), so that the electrical discharge section B of the electrode 32 is in a suspended state, and is capable of performing a reciprocating movement along the second direction Y along with reciprocating movements of the two carrying members 40. As shown in FIG. 7, the electrode 32 is not limited to surrounding the two carrying members 40, and the electrode 32 can also optionally span across only top sides of the two carrying members 40.

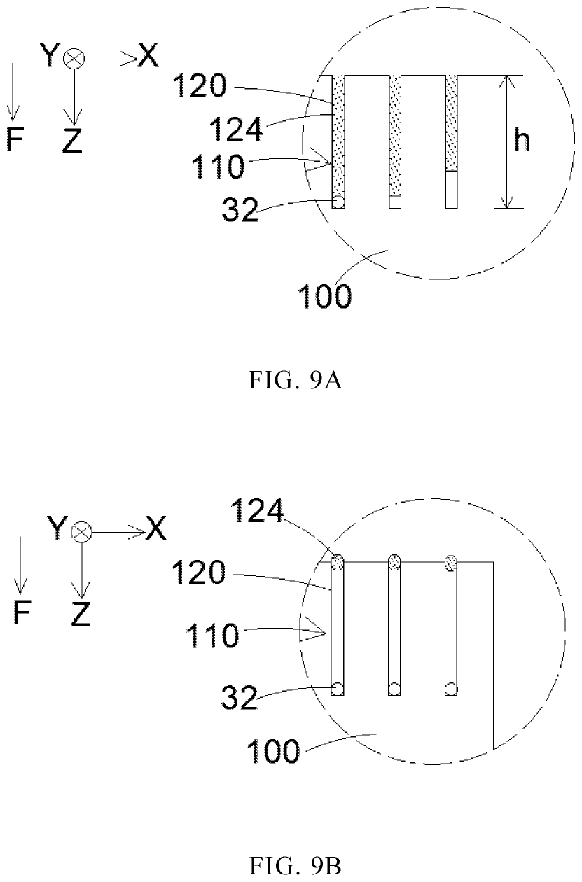

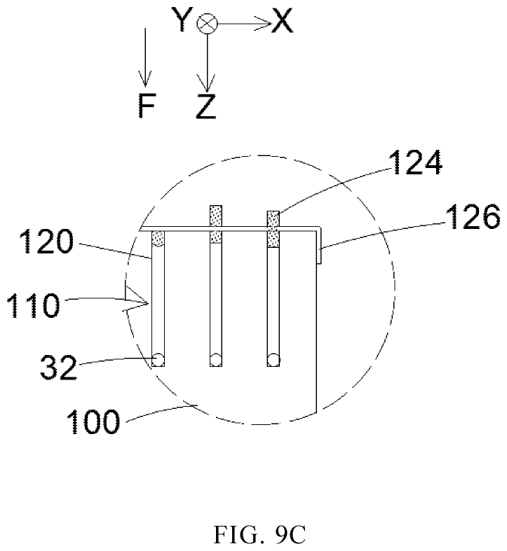

As shown in FIG. 9A, in the electrical discharge machining procedure, the electrical discharge machining unit 30 applies an electrical discharge energy to the machined target area 110 of the to-be-machined object 100 along the machining direction F through the electrical discharge section B of the electrode 32, so a plurality of machining grooves 120 are formed on the machined target area 110 of the to-be-machined object 100 along the machining direction F, wherein a depth h of the machining grooves 120 will be deepened with progress of the electrical discharge machining procedure until the entire electrical discharge machining procedure is completed. Wherein, as shown in FIG. 9A, the invention is also capable of optionally performing a filling procedure, so that the machining grooves 120 are optionally filled with a filling material 124, which is capable of reducing vibration of the to-be-machined object 100 and maintaining an as—cut/thinning distance of the to-be-machined object 100, and also capable of preventing the cut and ground to-be-machined objects 100 from colliding with one another. Wherein, the filling material 124 can be an insulating material such as air, deionized water, oil, glue, or other suitable insulating substances as a dielectric material. However, a material of the filling material 124 of the invention is not limited to the insulating material, any material (e.g., semi-insulating material or non-insulating material) as long as it is capable of being used to fill the machining grooves 120, it belongs to a scope of protection claimed by the invention. Moreover, depending on actual process requirements, the electrical discharge machining procedure and the filling procedure can be performed synchronously, sequentially or alternately. For example, after the machining grooves 120 with partial depth are formed and before the machining grooves 120 completely penetrate the to-be-machined object 100. The invention can also optionally perform the filling procedure on the machining grooves 120, as shown in FIG. 9B, for example, a glue dispensing step is performed on the machining grooves 120, which uses a glue as the filling material 124 to stick to machining surfaces on two sides of the machining grooves 120, which is capable of reducing shaking of the to-be-machined object 100 due to formation of the machining grooves 120, wherein the glue can be conductive glue or non-conductive glue, and the glue is not limited to partially filling or completely filling the machining grooves 120, as long as it is capable of exerting a bonding effect, it belongs to a scope of protection claimed by the invention. Or, as shown in FIG. 9C, the invention can also optionally use metal foil or metal block as the filling material 124, and fill the filling material 124 into the machining grooves 120, wherein the metal foil or metal block can be, for example, a conductive material such as copper foil or copper sheet, which is also capable of reducing shaking of the to-be-machined object 100. By the same token, the metal foil or metal block is not limited to partially filling or completely filling the machining grooves 120, and the filling material 124 is not limited to conductive materials such as metal foil or metal block, and objects such as insulating blocks can also be optionally used as the filling material 124, as long as a filling effect can be exerted, it belongs to a scope of protection claimed by the invention. In addition, the invention can also optionally carry out a step of sticking a tape on the to-be-machined object 100 formed with the machining grooves 120, for example, sticking a conductive or non-conductive adhesive tape 126 on two sides of the machining grooves 120 of the to-be-machined object 100, not only capable of exerting a fastening effect to reduce shaking of the machined target area 110 of the to-be-machined object 100, if the machining grooves 120 are filled with the filling material 124 such as metal foil or metal block, it is also capable of using the filling material 124 as a supporting element to support two sides of the machining grooves 120, which is capable of effectively preventing the sheet-like to-be-machined object 100 from being cracked or crushed by an external force during or after a machining process. For example, if the filling material 124 is a conductive material such as metal foil or metal block, and the electrical discharge machining procedure and the filling procedure are performed alternately, the invention can, for example, perform a first period of the electrical discharge machining procedure to form some of the machining grooves 120, and then perform a second period of the electrical discharge machining procedure, for example, fill the filling material 124 such as metal foil or metal block into the machining grooves 120, and then stick with the adhesive tape 126. By the same token, the invention can also perform a third period of the electrical discharge machining procedure to form the rest of the machining grooves 120, and then perform a fourth period of the filling procedure, and so on. Thereby, the machining grooves 120 can be partially filled or completely filled. In addition, the invention is not limited to applying an electrical discharge energy to the machined target area 110 of the to-be-machined object 100 in liquid or gaseous fluids to perform the electrical discharge machining procedure. The electrical discharge machining procedure of the invention can also be performed in a vacuum environment, discharge loss and impurity pollution can be reduced by the vacuum environment, and fineness and controllability of electrical discharge machining can also be increased. Alternatively, the above-mentioned liquid or gaseous fluids can be, for example, components containing oxygen or ozone. By performing the electrical discharge machining procedure in an oxygen-containing environment or an ozone-containing environment, not only an electrical discharge machining speed can be increased and an electrical discharge machining quality can be improved, but also capable of facilitating removal of carbides or residues formed on surfaces of the electrodes 32, thereby reducing electrode wear. In short, in addition to dry cutting the to-be-machined object 100 in a gaseous fluid environment or a vacuum environment in the electrical discharge machining procedure of the invention, the to-be-machined object 100 can also be soaked in a liquid fluid tank (such as a liquid tank or a heating liquid tank) or a liquid fluid is sprayed on the to-be-machined object 100 to wet cut the to-be-machined object 100 in a wet environment. For example, the above-mentioned fluid can optionally be an electrolyte (not shown in the figures) such as electrolyzed water, so that the invention can, for example, perform the electrical discharge machining procedure in an electrolyte environment. Since the electrodes 32 are electrically connected to a cathode of the power supply unit 34 (as shown in FIGS. 1A-1B), and the to-be-machined object 100 is electrically connected to an anode of the power supply unit 34, an electrolytic reaction can be generated simultaneously during the electrical discharge machining procedure. The invention utilizes a cathodic protection phenomenon of electrolytic reaction to prevent metal components of the electrode 32 from dissolving in the electrolyte during the electrical discharge machining procedure, thereby reducing an occurrence of breakage of the electrode 32. Electrolytic reaction is capable of causing water in the electrolyte to generate hydrogen on the machined target area 110 of the to-be-machined object 100, and generation of hydrogen bubbles helps to remove residues in the machining grooves 120 and improve a cleaning effect of the to-be-machined object 100. Moreover, by virtue of the principle that the same electrical property repels each other, negatively charged residues can be prevented from adhering to the electrodes 32 or the machining grooves 120. Although the invention uses electrolyzed water as the electrolyte as an example, any gaseous or liquid fluid capable of producing electrolytic reaction belongs to a scope of protection claimed by the invention.

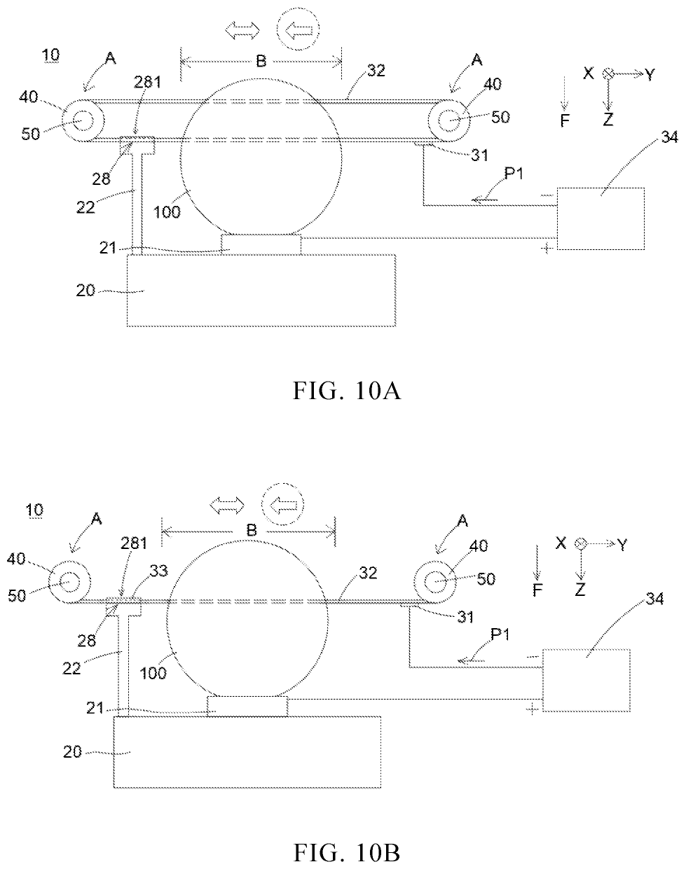

As shown in FIGS. 10A and 10B, since in the electrical discharge machining procedure, the electrical discharge section B of the electrode 32 advances along the machining direction F to apply an electrical discharge energy to the machined target area 110 of the to-be-machined object 100, and the electrical discharge section B of the electrode 32 and the machined target area 110 of the to-be-machined object 100 move relatively along the second direction Y at the same time (a direction as shown by hollow double arrows and single arrows in FIGS. 10A and 10B); therefore, in order to avoid chattering phenomenon of the electrode 32 during the electrical discharge machining procedure, the electrical discharge machining apparatus 10 of the invention is optionally provided with a stabilizing member 22, wherein the stabilizing member 22 is, for example, disposed on the carrier platform 20 or the jig 36, a position of the stabilizing member 22 is, for example, located between the two sides A of the electrode 32, a shape of the stabilizing member 22 is not particularly limited, as long as it is capable of reducing chattering of the electrode 32, it is applicable to the invention. For example, a contact surface 28 where the stabilizing member 22 is in contact with the electrode 32 can be, for example, a plane, by supporting the electrode 32 in a suspended state, chattering phenomenon can be reduced, or the contact surface 28 where the stabilizing member 22 is in contact with the electrode 32 can optionally have a guide groove 281, as shown in FIG. 10B. A depth of the guide groove 281, for example, is sufficient to movably accommodate the electrode 32. A quantity of the guide grooves 281 corresponds to the electrodes 32, so that a spacing between the electrodes 32 can be maintained and oscillation along the first direction X can be reduced for effectively stabilizing the electrodes 32 and providing a guiding effect. The guide groove 281 can not only support the suspended electrode 32, but also stabilize the electrode 32 and provide a guiding effect when the electrode 32 moves relative to the to-be-machined object 100 in a reciprocating or cyclical manner. In addition, the stabilizing member 22 can also be optionally designed with a height retractable structure, so that the depth h of the machining grooves 120 can be changed, thereby changing a height of the contact surface 28 where the stabilizing member 22 is in contact with the electrode 32. Wherein a strip structure between the two adjacent guide grooves 281 of the stabilizing member 22 can be used as a separation column (will be described hereinafter) to separate the electrodes 32 and make the electrodes 32 parallel to one another. The stabilizing member 22 can be made of non-conductive material to prevent the electrodes 32 from electrically contacting one another. However, if the stabilizing member 22 is made of conductive material, the stabilizing member 22 can further be used as the electrical contact 31.

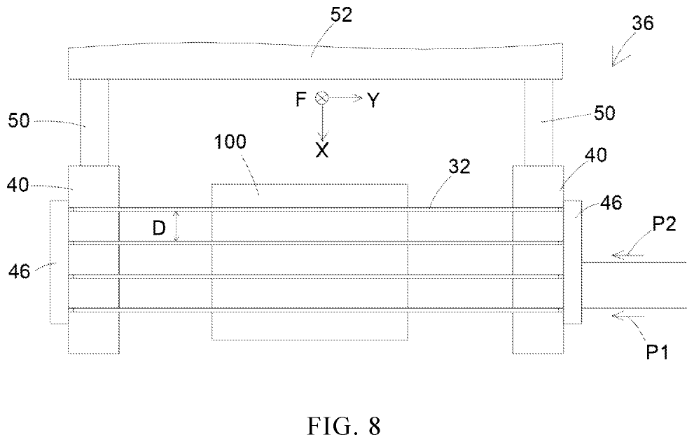

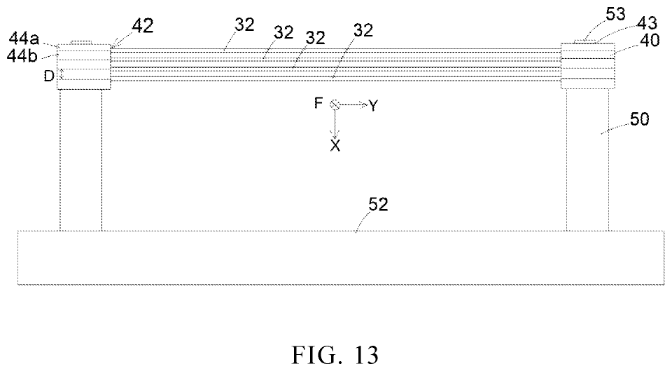

In the invention, a shape of the carrying member 40 is not particularly limited, and can be, for example, a plate structure (as shown in FIGS. 12 and 13) or a sleeve structure (as shown in FIGS. 1A-1B to 10A-10B). A surface of the carrying member 40, for example, optionally have a plurality of limiting grooves 42, wherein positions of the electrodes 32 are limited in the limiting grooves 42, the electrodes 32 in the different limiting grooves 42 can be electrically independent, or can be connected in sequence to be electrically connected to one another. In implementation modes shown in FIGS. 1A-1B to 13, the limiting grooves 42 are also arranged in parallel to one another along the first direction X by spacing apart by the distance D, so that the electrodes 32 are arranged in parallel to one another along the first direction X. However, the invention is not limited thereto. According to requirements of the actual electrical discharge machining procedure, in a feasible implementation mode of the invention, the limiting grooves 42 can also be, for example, arranged in parallel along the machining direction F, so that the electrodes 32 can be arranged in parallel along the machining direction F. A width of the limiting groove 42 corresponds to a width of the electrode 32, for example, a width of the limiting groove 42 is slightly larger than a width of the electrode 32, so that a position of the electrode 32 can be limited in the limiting groove 42. Wherein, the two carrying members 40 can be provided with the limiting grooves 42, for example. If the electrode 32 and the carrying member 40 do not need to move relative to each other, for example, if the carrying member 40 does not need to rotate, then the invention can further optionally fix the electrode 32 in the limiting groove 42 by an attachment member 46 (as shown in FIGS. 7 and 8), the attachment member 46 is connected to the electrode 32 at an edge of the carrying member 40, for example, wherein the attachment member 46 has a plurality of protrusions with positions and sizes corresponding to the limiting grooves 42, or the attachment member 46 can also be a glue. In addition, the attachment member 46 can further be optionally electrically connected to the first power source P1 supplied by the power supply unit 34 or a second power source P2 supplied by another power supply unit 34′, wherein the second power source P2 can be, for example, a DC power supply or a radio frequency. That is to say, the attachment member 46 can further be optionally used as the electrical contact 31 of FIGS. 1A-1B.

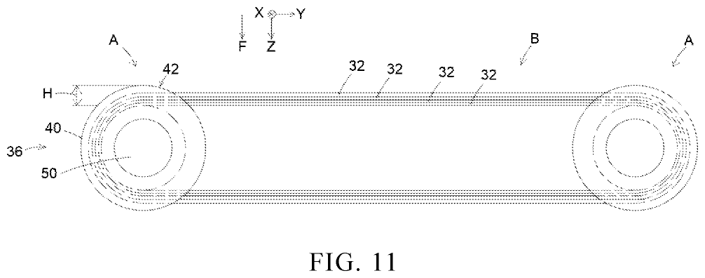

Please refer to an implementation mode shown in FIG. 11, and refer to FIGS. 1A-1B to as well, taking the carrying member 40 of the jig 36 as a cylindrical sleeve structure as an example, multiple limiting grooves 42 are, for example, arranged parallel along the first direction X (i.e., an axial direction of the carrying member 40), and go deep into the carrying member 40 along a third direction Z (i.e., a radial direction of the carrying member 40) to have a depth H, so single electrode 32 or multiple electrodes 32 can be stacked in the same limiting groove 42 (as shown in FIG. 11). Wherein the depth H of the limiting groove 42 can be determined according to actual requirements, and the depths H of the limiting grooves 42 are not limited to be the same as one another, that is, the depths H of multiple limiting grooves 42 arranged in parallel along the first direction X can also be different from one another. Wherein, taking the electrodes 32 in a surrounding design as an example, the electrodes 32 are in contact with one another to present a stacked state, and are stacked in the limiting groove 42 by wrapping the carrying member 40 around. In addition, a quantity of the electrodes 32 in the different limiting grooves 42 is not limited to be the same, that is, a quantity of the electrodes 32 in the different limiting grooves 42 can also be different from one another. In other words, the electrodes 32 arranged in parallel along the first direction X can be arranged in parallel along the third direction Z in a same quantity, or the electrodes 32 arranged in parallel along the first direction X can be arranged in parallel along the third direction Z in a different quantity. The third direction Z is, for example, perpendicular to the first direction X, that is, the third direction Z is a radial direction of the carrying member 40 and is parallel to a radial direction of the to-be-machined object 100. However, according to actual process requirements, the electrical discharge machining procedure can be vertical cutting or electrical discharge grinding along a radial direction of the to-be-machined object 100, or oblique cutting or electrical discharge grinding along a radial direction of the to-be-machined object 100 at an inclination angle. Therefore, when actually performing the electrical discharge machining procedure, for example, the carrier platform 20 or the jig 36 can be adjusted in order to adjust the third direction Z to be parallel to the machining direction F.

The holding member 50 is optionally detachably or fixedly assembled with the carrying member 40 stably, and there is no special limitation on a combination between the carrying member 40 and the holding member 50, as long as the carrying member 40 can be assembled to the holding member 50, or the carrying member 40 can be optionally moved or rotated by movement or rotation of the holding member 50, it is applicable to the invention. The carrying member 40 is, for example, a cylindrical sleeve (as shown in FIGS. 2A-2C) or a sleeve in another shape with a shaft hole 41, and the carrying member 40 can be sleeved on a protrusion 53 of the holding member 50 through the shaft hole 41. In addition, in order to reduce a time required to replace the electrode 32 when the electrode 32 breaks accidentally, in the invention, for example, the shaft hole 41 of the carrying member 40 can also be sleeved on a dummy support member that also has a protrusion. Thereby, a user is capable of quickly taking out the carrying member 40 surrounded by the electrodes 32 from the dummy support member, and sleeving the shaft hole 41 of the carrying member 40 on the protrusion 53 of the holding member 50, or inserting the protrusion 53 of the holding member 50 into the shaft hole 41 of the carrying member 40, so assembly of the jig 36 can be completed quickly.

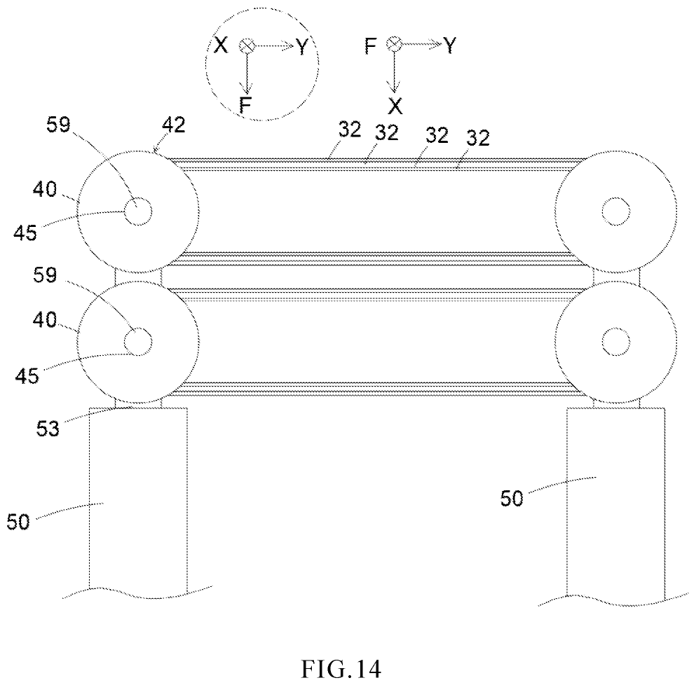

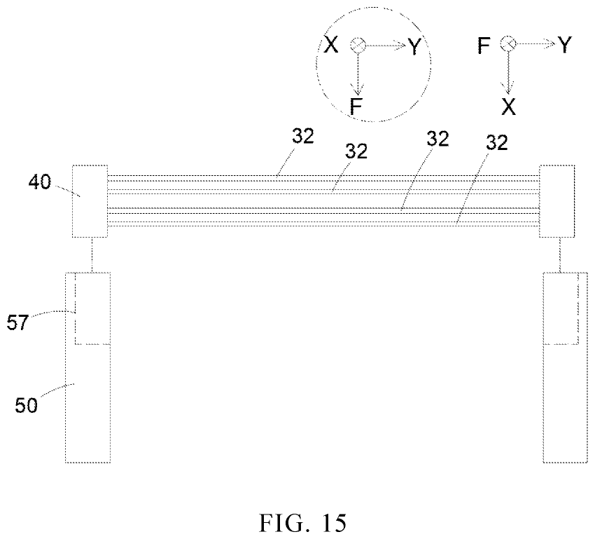

Taking a plate structure as an example, as shown in different implementation modes in FIG. 12 and FIG. 13, wherein a viewing angle of FIG. 13 is perpendicular to FIG. 12, the carrying members 40 respectively comprise a first sheet 44a and a second sheet 44b, and the electrode 32 is clamped between the first sheet 44a and the second sheet 44b. Taking FIG. 12 as an example, the electrode 32 is first wound on the first sheet 44a, and the second sheet 44b is then combined on the first sheet 44a, and the second sheet 44b is, for example, combined with a fitting groove of the first sheet 44a, thereby providing the limiting groove 42 to clamp the electrode 32. The carrying member 40 optionally has a through groove 43, and the carrying member 40 can be sleeved on a protrusion 53 of the holding member 50 through the through groove 43. The through groove 43 is not limited to opening on one side or opening on two sides, as long as the carrying member 40 and the holding member 50 can be assembled together, any mode of the through groove 43 or assembly method is applicable to the invention. Taking FIG. 13 as an example, the electrode 32 is sandwiched between the first sheet 44a and the second sheet 44b. The carrying member 40 is provided with, for example, the through groove 43, and the carrying member 40 can be sleeved on the protrusion 53 of the holding member 50 through the through groove 43. The second sheet 44b can be used as a separation layer between the wound electrodes 32 in multilayers, and the distance D between the multilayer electrodes 32 in the first direction X can be adjusted by changing a thickness of the second sheet 44b. Or, as shown in an implementation mode in FIG. 14, the carrying member 40 can optionally be assembled with the holding member 50 by screwing, for example, the carrying members 40 respectively have a through hole 45, and the protrusions 53 of the holding members 50 have a screw hole respectively, wherein the carrying member 40 is screwed with the screw holes of the holding member 50 by passing a bolt 59 through each of the through holes 45. Or, as shown in an implementation mode in FIG. 15, the holding members 50 can also optionally have a groove structure 57 respectively, for example, and the carrying member 40 is inserted into the groove structure 57 of the holding member 50 to be correspondingly assembled on the holding member 50.

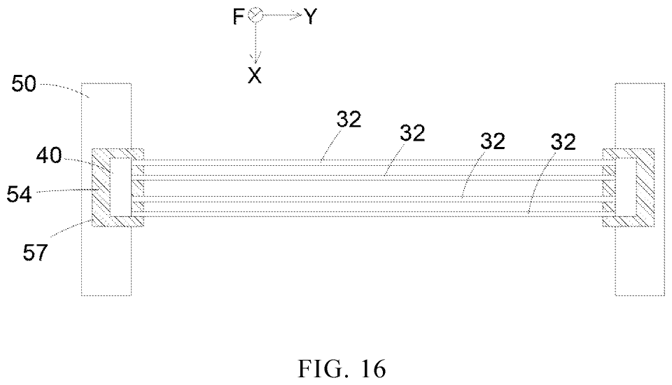

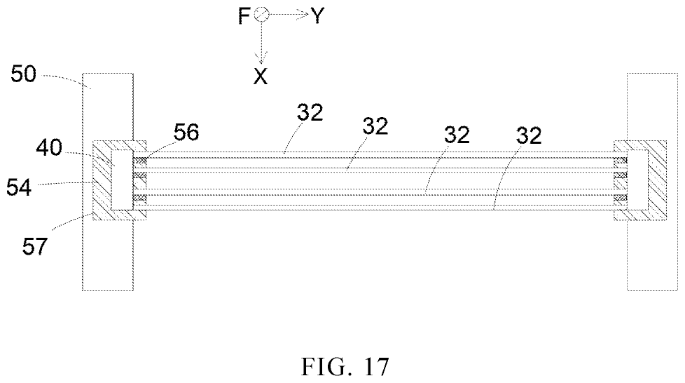

In addition, as shown in an implementation mode in FIG. 16, the holding member 50 can further have a conductive structure 54, for example, the conductive structure 54 is, for example, straddling multiple electrodes 32 along the first direction X in order to be electrically connected to the electrodes 32 abutting against the carrying member 40. Thereby the first power source P1 provided by the power supply unit 34 in the foregoing implementation mode can be optionally electrically connected to the electrodes 32, for example, via the conductive structure 54, that is, the conductive structure 54 can be optionally used as the electrical contact 31 in FIGS. 1A-1B. In addition, an insulating structure 56 can further be optionally provided between the electrodes 32 to prevent the electrodes 32 from being in electrical contact with one another. For example, in an implementation mode shown in FIG. 17, the insulating structure 56 can be optionally, for example, disposed between the electrodes 32 and the conductive structure 54. Wherein a material of the insulating structure 56 is not particularly limited, as long as it is capable of providing the above-mentioned insulating effect, it is applicable to the invention.

In addition, in various implementation modes of the invention, heights of the electrodes 32 in the different limiting grooves 42 are not limited to be the same, and heights of the electrodes 32 in the different limiting grooves 42 can also be different from one another. Alternatively, heights of the electrodes 32 on the different carrying members 40 are not limited to be the same, and heights of the electrodes 32 located on the different carrying members 40 can also be different from one another. That is, as shown in an implementation mode in FIG. 11, the electrodes 32 can not only be arranged in parallel along the first direction X, but can also be optionally arranged in parallel along the third direction Z at a same height or at different heights. Wherein the electrodes 32 located in the same limiting groove 42 can be stacked on one another or arranged in parallel.

In addition, as shown in FIG. 11, since multiple electrodes 32 located in the same limiting groove 42 are arranged in parallel along the third direction Z (the machining direction F), when the electrodes 32 arranged in parallel along the third direction Z sequentially perform cutting or electrical discharge grinding on the machined target area 110 of the to-be-machined object 100 along the machining direction F, the electrode 32 located behind will pass a position again that the electrode 32 located in front has already passed. In other words, taking the machining direction F from top to bottom as an example, even if the front electrode 32 (such as the electrode below) is disconnected, the rear electrode 32 (such as the electrode above) can still replace the front electrode 32 to apply an electrical discharge energy to the machined target area 110 of the to-be-machined object 100 shown in FIGS. 1A-1B. Therefore, the invention is capable of avoiding adverse effects such as process interruption caused by disconnection of the electrode 32 through electrode replacement function.

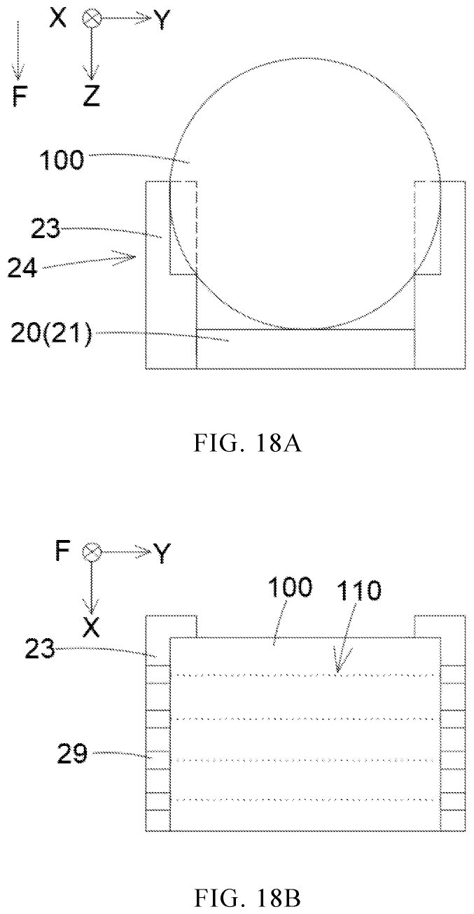

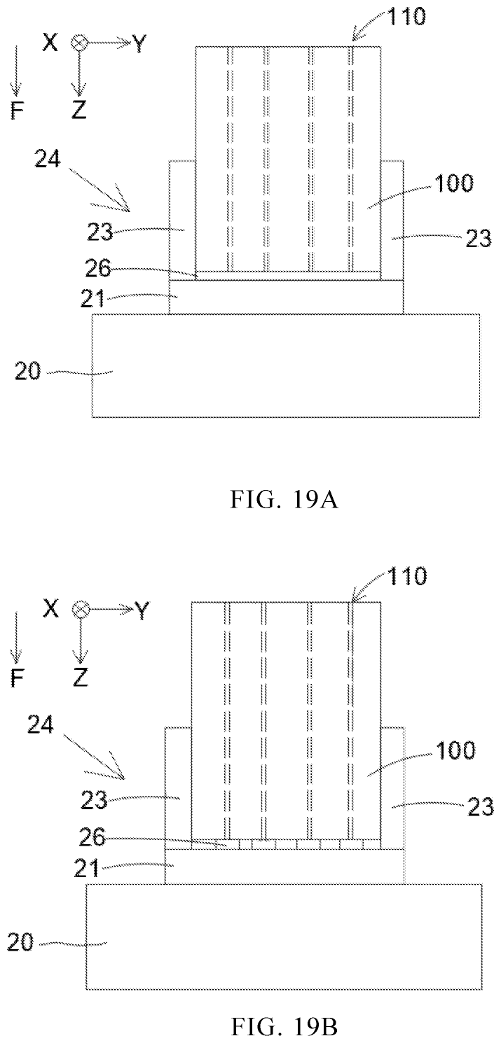

The to-be-machined object 100 is placed on the carrier platform 20, and the carrier platform comprises a clamping element 24 for fixing the to-be-machined object 100, wherein the clamping element 24 has two plate bodies 23, and optionally comprises the carrier plate 21. As shown in FIGS. 18A and 18B, the plate body 23 of the clamping element 24 can optionally be a stepped structure, and a stepped design is capable of contacting and abutting against more positions on the to-be-machined object 100 in order to achieve an effect of clamping the to-be-machined object 100 stably. However, a shape of the clamping element 24 of the invention is not particularly limited, as long as it is capable of clamping the to-be-machined object 100, it belongs to a scope of protection claimed by the invention. For example, taking the to-be-machined object 100 as a block (such as an ingot) as an example, the clamping element 24 can, for example, clamp a peripheral edge of an ingot cylinder, as shown in FIGS. 18A and 18B, in order to prevent scrolling or displacement, and the machined target area 110 of the to-be-machined object 100 is located on an outer side the clamping element 24. Alternatively, the clamping element 24 can, for example, clamp two ends of an ingot, that is, axially clamp two sides of the ingot, as shown in FIGS. 19A and 19B, in order to avoid displacement and make the machined target area 110 of the to-be-machined object 100 to be located between the two clamping elements 24. Wherein the clamping elements 24 can be, for example, the two plate bodies 23 disposed separately, and the two plate bodies 23 are used to clamp the to-be-machined object 100. By making the clamping element 24 and the to-be-machined object 100 have two or more than two contact surfaces, scrolling or displacement of the to-be-machined object 100 can be effectively avoided. Wherein the carrier plate 21 or the clamping element 24 of the carrier platform 20 can further be optionally connected to the to-be-machined object 100 with the adhesive layer 26, as shown in FIGS. 19A and 19B, thereby effectively avoiding chattering (shaking) of the to-be-machined object 100 during the electrical discharge machining procedure or avoiding burrs before the electrical discharge machining procedure is completed, wherein the adhesive layer 26 is, for example, an conductive adhesive, and the adhesive is capable of providing conductive and fixing effects. Wherein the adhesive layer 26 can be provided continuously or discontinuously on the carrier platform 20 or the clamping element 24, to be continuously bonded between the to-be-machined object 100 and the carrier plate 21 of the carrier platform 20 as shown in FIG. 19A, or to be discontinuously bonded between the to-be-machined object 100 and the carrier plate 21 of the carrier platform 20 as shown in FIG. 19B. Taking the discontinuous type as an example, the adhesive layer 26 is, for example, disposed at intervals on the carrier plate 21 of the carrier platform 20, and its position, for example, corresponds to the machined target area 110, that is, a position of the adhesive layer 26 is located below the machined target area 110. However, in the invention, a position of the adhesive layer 26 is not limited to be directly below the machined target area 110, as long as it is capable of fixing the to-be-machined object 100, any position belongs to a scope of protection claimed by the invention.

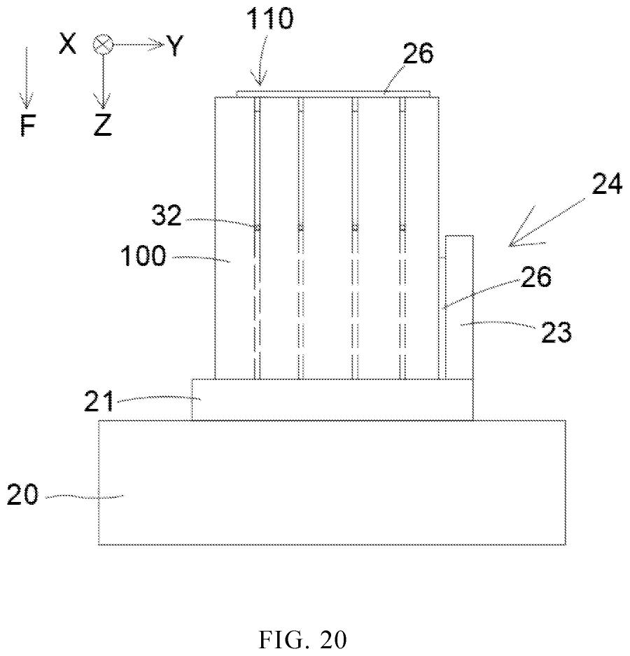

In an implementation mode shown in FIG. 20, the clamping element 24 can further be formed by combining single plate body 23 and the carrier plate 21, for example, single plate body 23 is used to support one side of the to-be-machined object 100, and the carrier plate 21 is used to support a bottom side of the to-be-machined object 100. In other implementation modes, the clamping element 24 of the invention can also omit the carrier plate 21, and only single plate body 23 is located on the carrier platform 20. In addition, the invention can further optionally use the adhesive layer 26 to fix two groove walls of the machining grooves 120 of the machined target area 110 of the to-be-machined object 100 in order to avoid chattering of the to-be-machined object 100 during the electrical discharge machining procedure, and further avoid burrs before the electrical discharge machining procedure is completed. Wherein the to-be-machined object 100 is not limited to be fixed on one side of the clamping element 24 via the adhesive layer 26 at two ends in an axial direction or at a peripheral edge in a radial direction. As mentioned above, the adhesive layer 26 can be located on the to-be-machined object 100 continuously or discontinuously. The adhesive layer 26 is, for example, disposed on the to-be-machined object 100 at intervals, and its position corresponds to, for example, but not limited to, the machined target area 110 of the to-be-machined object 100.

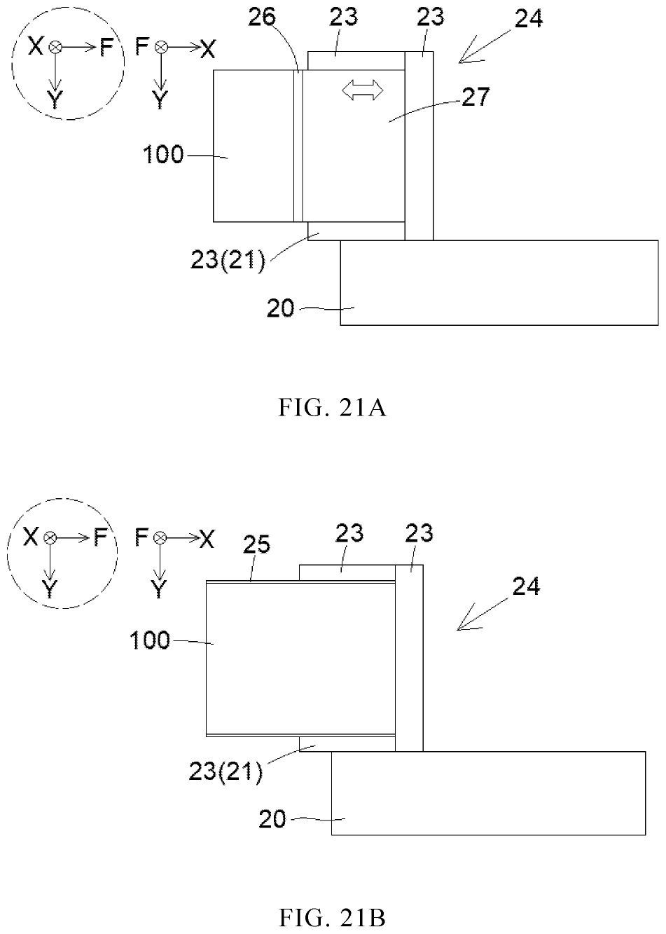

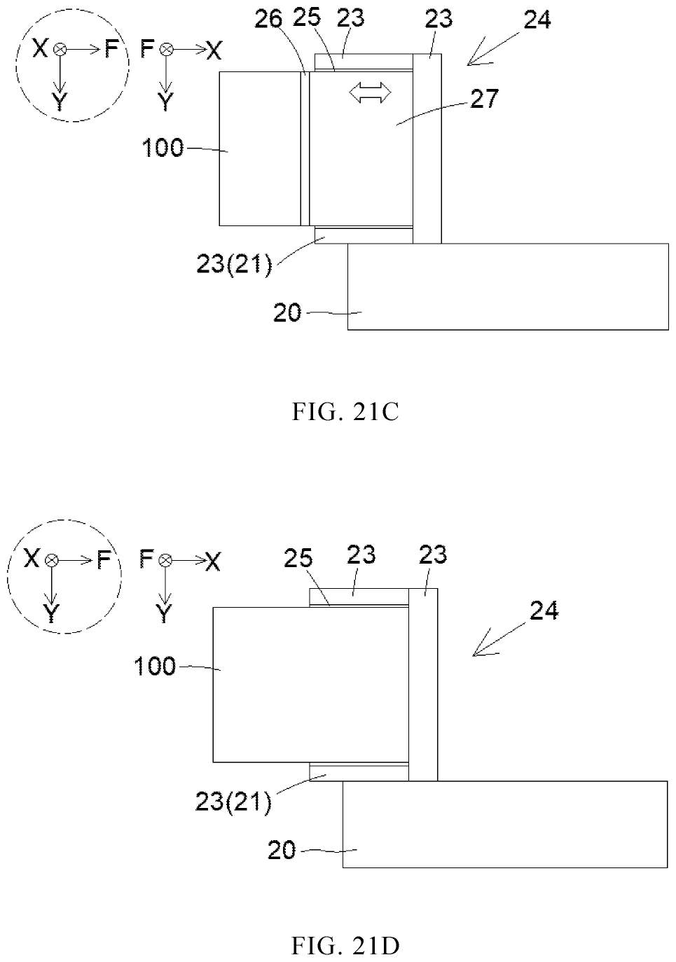

As shown in an implementation mode in FIG. 21A, the clamping element 24 can be formed by combining multiple plate bodies 23, or formed by combining the plate body 23 and the carrier plate 21, and can further, for example, clamp a buffer member 27. The buffer member 27 fixes the to-be-machined object 100 through the adhesive layer 26. The electrical discharge machining unit 30 performs the electrical discharge machining procedure on the to-be-machined object 100 on the carrier platform 20 along the machining direction F (for example, perpendicular to a paper surface or parallel to a paper surface), even for example, performs the electrical discharge machining procedure on the to-be-machined object 100 and the buffer member 27. The adhesive layer 26 is optionally, for example, a conductive glue layer. Wherein, the to-be-machined object 100 is not limited to be fixed on the buffer member 27 via the adhesive layer 26 at two ends in an axial direction or at a peripheral edge in a radial direction. The buffer member 27 can also be made of a conductive material, for example, but because a purpose of the buffer member 27 is to enable the clamping element 24 to indirectly clamp the to-be-machined object 100 in order to perform the electrical discharge machining procedure, the buffer member 27 is not limited to a specific structure or material, as long as the above-mentioned object can be achieved, it belongs to a scope of protection claimed by the invention.

As shown in FIGS. 21B, 21C and 21D, the clamping element 24 can also fix the to-be-machined object 100 by clamping a conductive frame 25, the electrical discharge machining unit 30 performs the electrical discharge machining procedure on the to-be-machined object 100 on the carrier platform 20 along the machining direction F (for example, perpendicular to a paper surface or parallel to a paper surface), even for example, performs the electrical discharge machining procedure on the to-be-machined object 100 and the conductive frame 25. Wherein the to-be-machined object 100 is not limited to be fixed on the clamping element 24 via the conductive frame at two ends in an axial direction or at a peripheral edge in a radial direction, as long as the electrical discharge machining procedure can be performed, it belongs to a scope of protection claimed by the invention. Moreover, depending on actual process requirements, the conductive frame 25 of the invention can be optionally attached to a periphery of the to-be-machined object 100 partially (as shown in FIGS. 21C and 21D) or attached to a periphery of the to-be-machined object 100 completely (as shown in FIG. 21B).

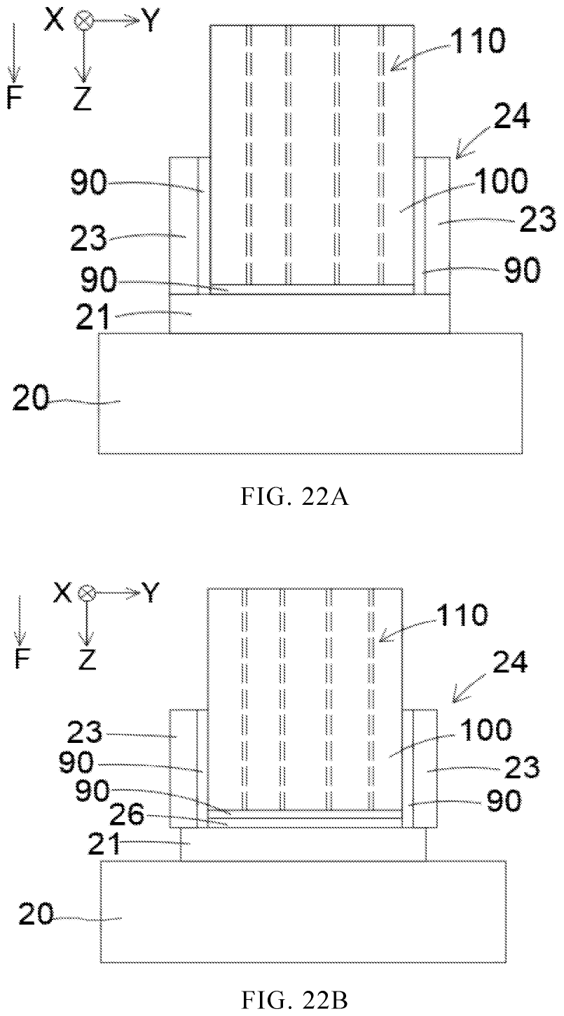

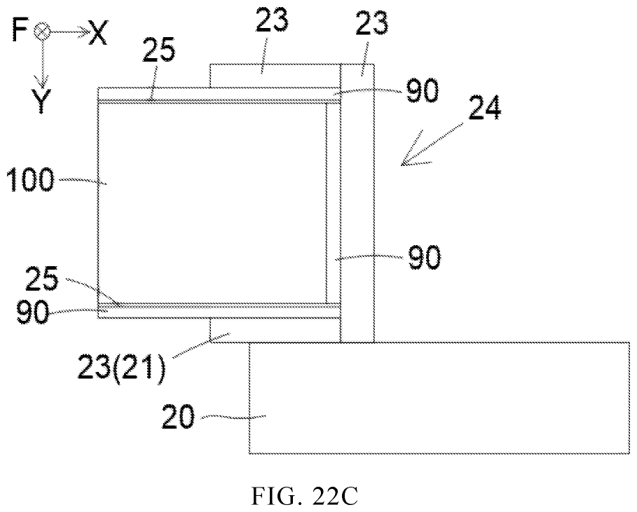

In addition, in order to improve an efficiency of the electrical discharge machining procedure, the invention is capable of further improving an electrical contact between the to-be-machined object 100 and the clamping element 24 through a conductive gain layer, or improving an electrical contact between the to-be-machined object 100 and the carrier platform 20. For example, as shown in FIGS. 22A-22C, the invention is capable of forming a conductive gain layer 90 on the to-be-machined object 100 through a surface modification method (for example, electrical discharge machining or laser), and then clamping the to-be-machined object 100 with the clamping element 24. Components of the conductive gain layer 90 depend on a composition of the to-be-machined object 100. A formation position of the conductive gain layer 90, for example, corresponds to a clamped position (i.e., a contact surface) of the to-be-machined object 100. For example, the conductive gain layer 90 can be formed at a position where the to-be-machined object 100 contacts the plate body 23 on two sides of the clamping element 24 and/or the carrier plate 21 below. In other implementation modes, if the carrier plate 21 below the clamping element 24 is omitted, the invention, for example, can also use the conductive gain layer 90 to directly contact the carrier platform 20. The invention is capable of improving an electrical contact between the to-be-machined object 100 and the clamping element 24 (or the carrier platform 20) by modifying a surface of the to-be-machined object 100. Alternatively, the invention is capable of providing good electrical contact by forming the conductive gain layer 90 through plating or coating. Even, the conductive frame 25 shown in FIG. 21B is capable of forming the conductive gain layer 90 by plating or the conductive frame 25 itself is the conductive gain layer 90 to provide good electrical contact. Wherein the above-mentioned conductive gain layers 90 at different positions can be, for example, the same or different conductive materials, as long as good electrical contact can be provided, they are applicable to the invention. In addition, each of the components of the clamping element 24 of the invention, such as the plate body 23 and/or the carrier plate 21 itself, can also be made of conductive gain materials, for example, the conductive gain materials can be selected from different conductive materials or a same conductive material, such as different metal materials or a same metal material, as long as good electrical contact can be provided, they are applicable to the invention, thereby especially an electrical discharge machining efficiency of the to-be-machined object 100 such as semiconductors or poor conductors can be improved. A work function of the conductive gain layer 90 is, for example, below about 4.5 eV, but it is not limited thereto, as long as it is conducive to improving an electrical contact, it is applicable to the invention.

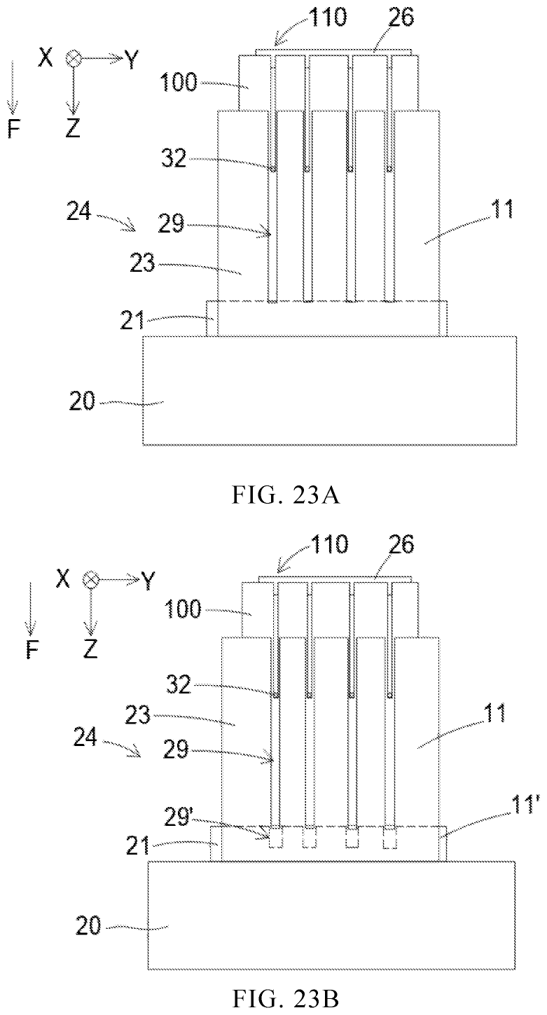

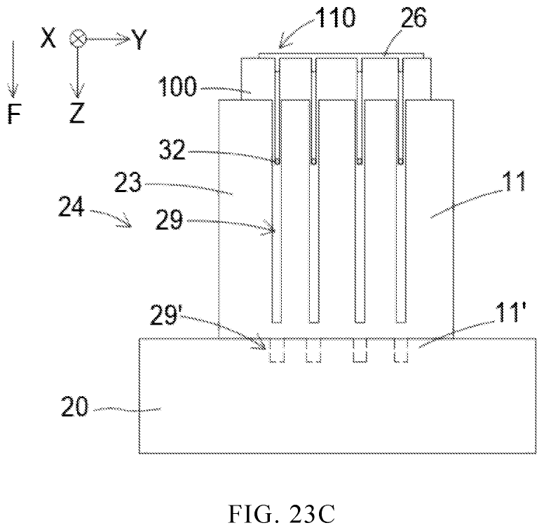

In addition, although the electrical discharge machining unit 30 is capable of performing the electrical discharge machining procedure on the to-be-machined object 100 on the carrier platform 20 and the clamping element 24 along the machining direction F, as shown in FIG. 23A and FIGS. 18A and 18B, the clamping element 24 of the invention can, for example, comprise the two plate bodies 23 and the carrier plate 21, wherein the two plate bodies 23 can optionally have a comb-like structure 11, for example, at least one of the two plate bodies 23 is formed with the comb-like structure 11 to become a comb-like plate, and a position of a comb-tooth opening 29 of the comb-like structure 11, for example, corresponds to a position of the machined target area 110, i.e. corresponds to a position of the electrode 32. However, the invention is not limited thereto, and the carrier plate 21 of the invention can also optionally have a comb-like structure 11′, as shown in an implementation mode in FIG. 23B. Wherein, if the carrier plate 21 is omitted, the comb-like structure 11′ can also be directly formed on the carrier platform 20, as shown in an implementation mode in FIG. 23C. In other words, according to actual structural design requirements, the clamping element 24 or the carrier platform 20 of the invention can optionally have the comb-like structure, or both the clamping element 24 and the carrier platform 20 have the comb-like structure, wherein a position of a comb-tooth opening 29′ of the comb-like structure 11′, for example, corresponds to a position of the machined target area 110, thereby not only capable of firmly clamping the to-be-machined object 100 for performing the electrical discharge machining procedure, but also capable of preventing the electrode 32 from damaging the clamping element 24 and the carrier platform 20. In addition, the comb-like structure of the invention is not limited to specific dimensions, materials, number of comb-tooth opening or disposing orientation, as long as the carrier platform 20 and/or the clamping element 24 are/is capable of clamping the to-be-machined object 100 during the electrical discharge machining procedure, it belongs to a scope of protection claimed by the invention.

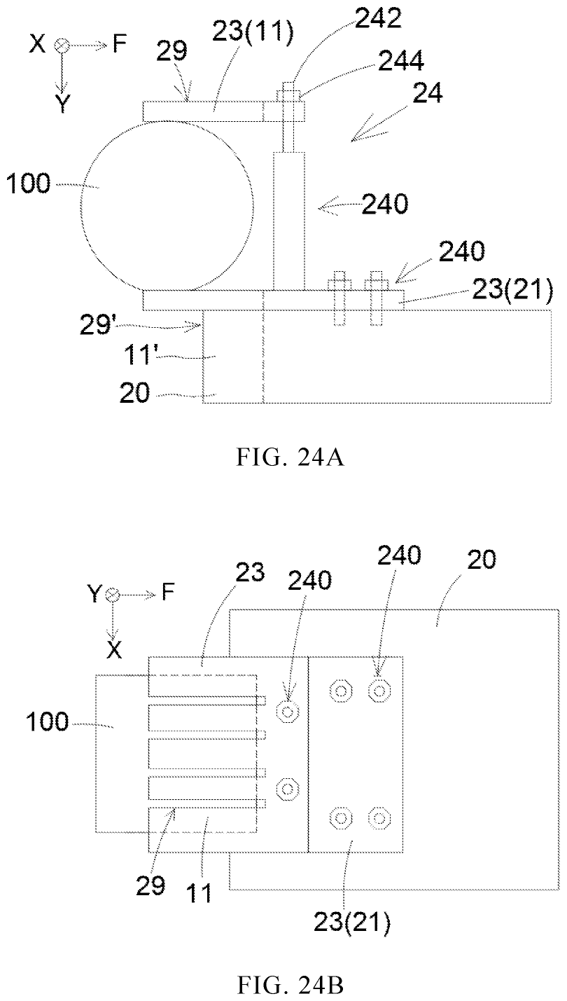

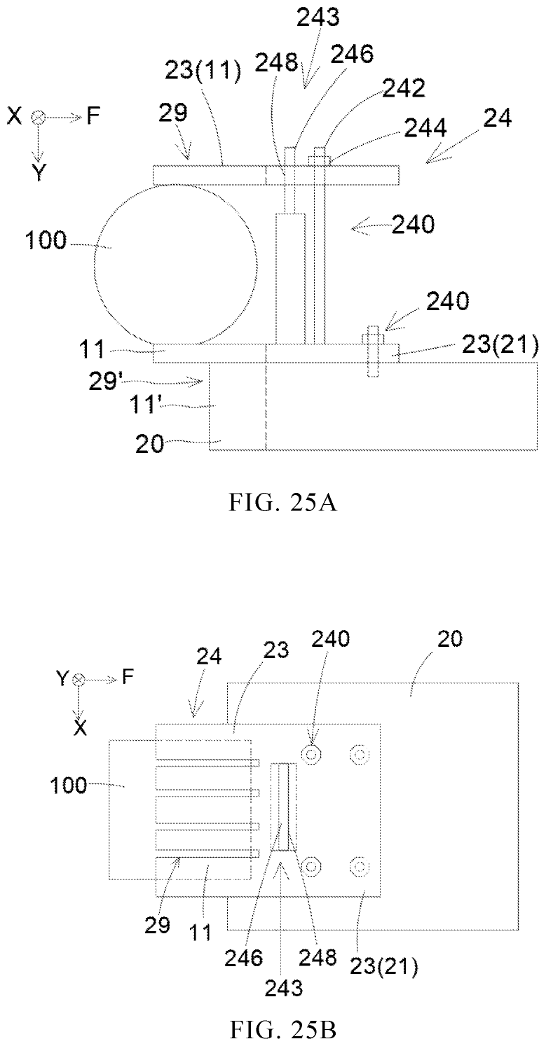

In the invention, the clamping element 24 is not limited to be located on the carrier platform fixedly or detachably. Taking a detachable design as an example, the two plate bodies 23 of the clamping element 24 can be detachably connected to each other, for example, by a lock-in structure 240, and the plate body 23 below can also be, for example, detachably connected on the carrier platform 20 by the lock-in structure 240, wherein both the lower plate body 23 and the carrier plate 21 in the above-mentioned figures are used for carrying, so the plate body 23 can also be replaced by the carrier plate 21, but for the sake of simplification, only the plate body 23 is used as an example for illustration. The clamping element 24 of the invention is capable of adjusting a distance between the two plate bodies 23 (that is, a width of a clamping opening) through the lock-in structure 240 in order to clamp the to-be-machined object 100 of different sizes, wherein the lock-in structure 240, for example, but is not limited to, comprising bolts 242 and nuts 244, as shown in FIGS. 24A and 24B, thereby not only capable of detachably clamping the to-be-machined object 100, but also capable of adjusting a width of a clamping opening correspondingly according to dimensions of the to-be-machined object 100. In addition, the lock-in structure 240 of the invention can be any structural design that enables the clamping element 24 to be detachably disposed on the carrier platform 20, that is, as long as a detachable effect can be achieved, it belongs to a scope of protection claimed by the invention. In addition, the two plate bodies 23 of the clamping element 24 of the invention can also be quickly connected by a snap-fit structure 243 optionally, such as a snapping block 246 (such as a protrusion) and a snapping hole 248 (such as a through hole) that are capable of sleeving with each other. For example, as shown in FIGS. 25A and 25B, the lower plate body 23 has the snapping block 246, and the upper plate body 23 has the corresponding snapping hole 248, so that the two plate bodies 23 can be connected with each other easily, and then the bolts 242 and the nuts 244 are used to make the upper plate body 23 firmly abut against the to-be-machined object 100. Thereby, not only an effect of quick disassembly and installation can be achieved, but an efficacy of increasing a structural strength can also be achieved. In addition, as shown in implementation modes in FIGS. 24A and 24B and FIGS. 25A and 25B, the two plate bodies 23 of the clamping element 24 can optionally have the comb-like structure 11, and the carrier platform 20 can also optionally have the comb-like structure 11′, wherein a position of the comb-tooth opening 29′ of the comb-like structure 11′, for example, corresponds to a position of the machined target area 110, thereby not only capable of firmly clamping the to-be-machined object 100 for performing the electrical discharge machining procedure, but also capable of avoiding damaging of the plate bodies 23 of the clamping element 24 and the carrier platform 20.

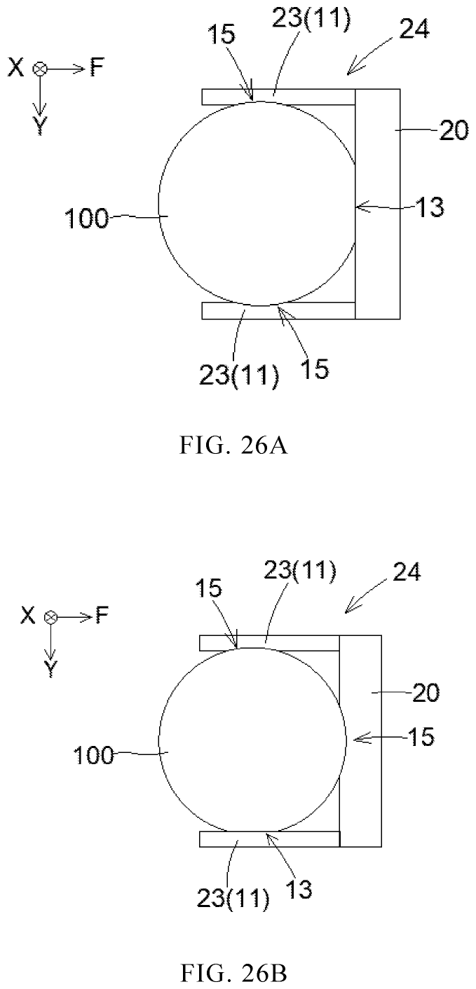

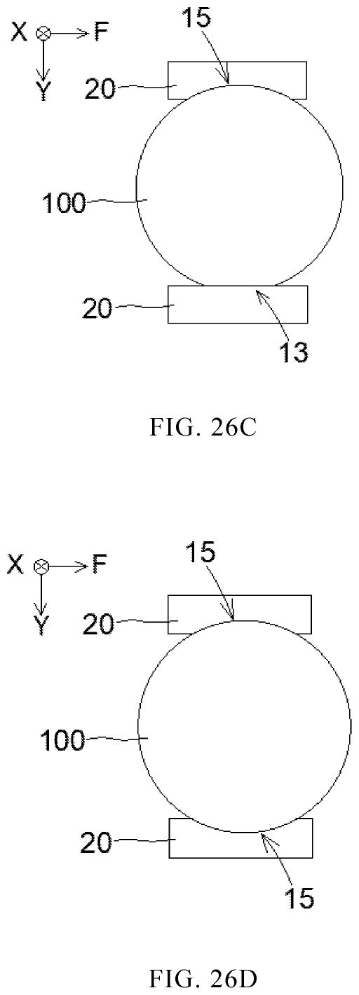

In addition, as shown in FIGS. 26A-26D, a radial section of the to-be-machined object 100 is not limited to a circle, and can be in any shape, for example, a circle with a planar area 13. Wherein the to-be-machined object 100 can be optionally connected to the carrier platform 20 with the planar area 13 (as shown in FIGS. 26A and 26C), or connected with the clamping element 24 with the planar area 13 (as shown in FIG. 26B). The invention is not limited to clamping the to-be-machined object 100 by using the clamping element 24 and the carrier platform 20 (as shown in FIGS. 26A and 26B), the invention can also, for example, omit the clamping element 24 and directly clamp the to-be-machined object 100 with the carrier platform 20 (as shown in FIGS. 26C and 26D), or clamp the to-be-machined object 100 with the carrier plate 21 (not shown in the figures) on the carrier platform 20. Wherein, if the to-be-machined object 100 is clamped on two or more than two sides, whether the to-be-machined object 100 is clamped by the clamping element 24 and/or the carrier platform 20, the to-be-machined object 100 can be stabilized and the to-be-machined object 100 can be prevented from scrolling or displacing. The clamping element 24 or the carrier platform 20 (or the carrier plate 21 on the carrier platform 20) of the invention can optionally have a shape corresponding to a shape of the to-be-machined object 100, for example, an arc groove 15 corresponding the to-be-machined object 100 with an arc-shaped contour, as shown in FIGS. 26A to 26D. In other words, when the clamping element 24 clamps the to-be-machined object 100, a shape of the clamping element 24 is capable of attaching (for example, conformal attachment) along a shape of the to-be-machined object 100 in order to obtain a better clamping effect, and capable of further avoiding scrolling or displacement of the to-be-machined object 100 during the electrical discharge machining procedure.

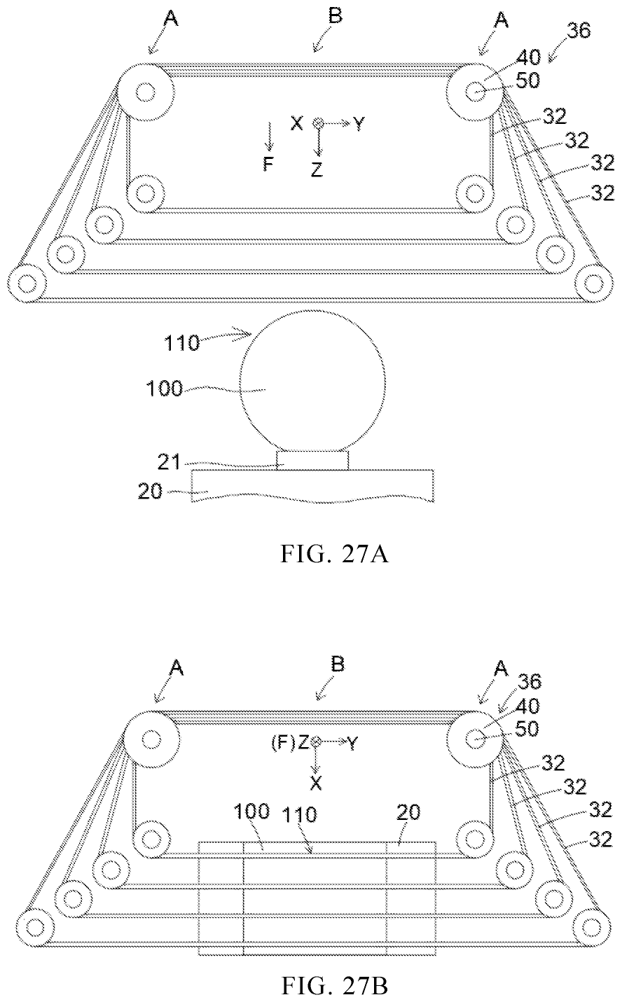

In other feasible embodiments, the electrical discharge machining unit 30 of the invention is capable of, for example, rotating two or more than two of the carrying members 40 in a reciprocating or cyclical manner in order to drive the electrical discharge sections B of multiple electrodes 32 to move reciprocatingly or cyclically. A connection configuration of the carrying members 40 and the electrodes 32 can be implemented in modes as shown in FIGS. 27A and 27B, and each of the electrodes 32 surrounds the four carrying members 40 respectively. FIGS. 27A-27B are schematic diagrams of two implementation modes of the invention in which the electrodes 32 are arranged in parallel through multiple carrying members 40, wherein FIG. 27A shows that the electrodes 32 are arranged in parallel along the machining direction F, so that multiple electrodes 32 are capable of sequentially performing the electrical discharge machining procedure on single machined target area 110, while FIG. 27B shows that the electrodes 32 are arranged in parallel along the first direction X, so that multiple electrodes 32 are capable of sequentially performing the electrical discharge machining procedure on multiple machined target areas 110 simultaneously. The electrodes 32 share the two carrying members 40 among the four carrying members 40, so the two sides A of the electrodes 32 are in contact with one another to present a stacked state and movably abut against the two shared carrying members 40. The rest of the carrying members 40 are disposed in pairs at different heights, so that the electrodes 32 are separately arranged in parallel to one another by a distance. Thereby, when the carrying members 40 rotate reciprocatingly or cyclically, the electrical discharge sections B of the electrodes 32 displace relative to the to-be-machined object 100, and the paired carrying members 40 disposed at different heights are located at different heights, that is, are arranged in parallel in pairs and separated by the distance. Wherein, the shared carrying members 40, for example, synchronously rotate in a reciprocating or cyclical manner at a same rotational speed, so reciprocating moving speeds or cyclical moving speeds of the electrodes 32 along the second direction Y are also the same.

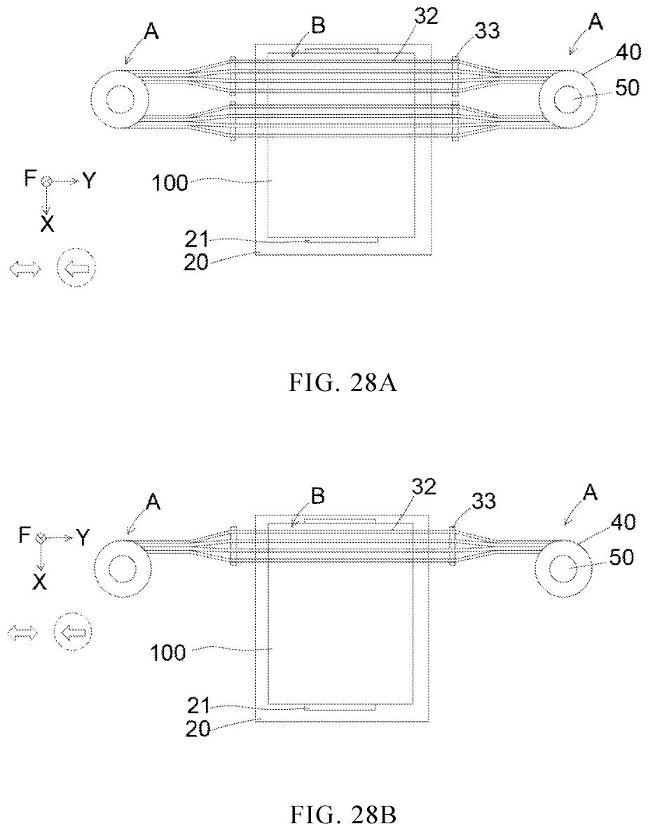

In other equally feasible embodiments, the electrical discharge machining unit 30 of the invention is capable of, for example, rotating the two carrying members 40 in a reciprocating or cyclical manner in order to drive the electrical discharge sections B of multiple electrodes 32 to move reciprocatingly or cyclically. For example, a disposing configuration of the carrying members 40 and the electrodes 32 can be implemented in modes shown in FIGS. 28A and 28B. The two sides A of the electrodes 32 are in contact with one another to present a stacked state and movably abut against the two carrying members 40. The electrical discharge sections B of the electrodes 32 are arranged parallel to one another and separated by separation columns 33 by a distance, thereby, when the carrying members 40 rotate reciprocatingly or cyclically, the electrical discharge sections B of the electrodes 32 displace relative to the to-be-machined object 100, and are separated by the separation columns 33 and arranged parallel to one another. Wherein the electrodes 32 are movable abutted against the separation columns 33, and positions of the separation columns 33 are fixed, but the separation columns 33 can have a fixed or rolling design, and have a limiting groove to serve as a guide column. The separation columns 33 can also be optionally made of conductive material, so that the electrodes 32 can be electrically connected to the power supply unit 34 through the separation columns 33, that is, the separation columns 33 can also be optionally used as the electrical contacts 31 in FIGS. 1A-1B. In addition, the separation columns 33 can also be made of insulating material to avoid electrical connection between the electrodes 32. Wherein the two carrying members 40, for example, synchronously perform reciprocating or cyclical rotations at a same rotation speed, so reciprocating or cyclical movement speeds of the electrodes 32 along the second direction Y are also the same.

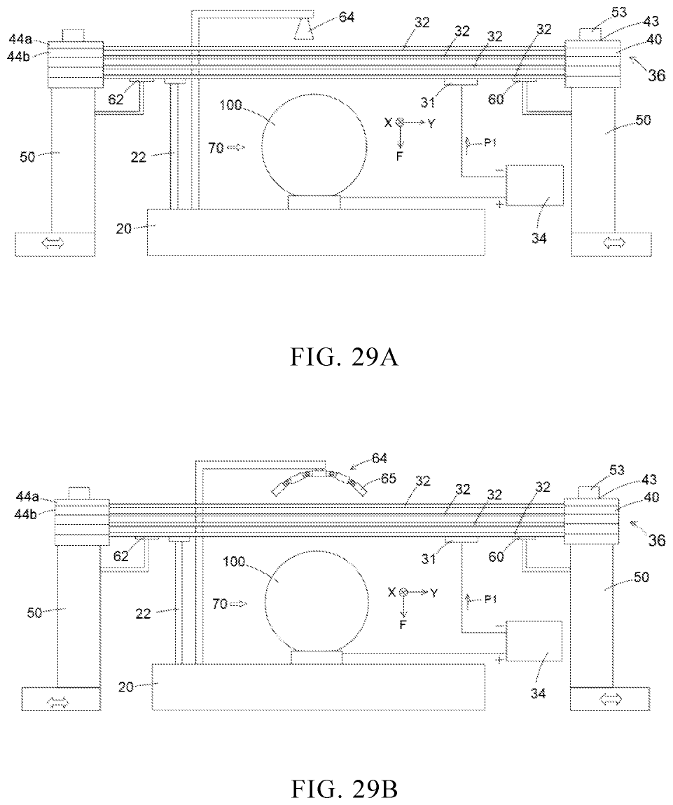

In addition, as shown in implementation modes in FIGS. 29A and 29B, the electrical discharge machining unit 30 has an adjustable tension value optionally, and for example, by making the two carrying members 40 or the two holding members 50 to produce relative displacement (as indicated by double arrows on lower left and right sides of FIGS. 29A and 29B), for example, moving toward or away from each other, thereby adjusting a tension value of the electrodes 32. As shown in FIGS. 29A and 29B, the electrical discharge machining unit 30 further comprises a tension measuring unit 60, such as a tensiometer, for measuring a tension value of the electrodes 32. As shown in FIGS. 29A and 29B, the electrical discharge machining apparatus 10 further comprises a vibration measuring unit 62 for measuring a vibration value of the electrodes 32.

As shown in FIGS. 29A and 29B, the electrical discharge machining unit 30 further comprises a slag removal unit 64, when the electrical discharge machining unit 30 performs the electrical discharge machining procedure on the to-be-machined object 100, the slag removal unit 64 provides one external force or more than one external force to eliminate residues generated by an electrical discharge energy applied by the electrode 32 to the to-be-machined object 100. Applied direction or applied position of the external force generated by the slag removal unit 64 corresponds to a shape of the to-be-machined object 100 in an adjustable manner, thereby applied direction or applied position of the external force corresponds to the electrical discharge section B of the electrode 32. Wherein the slag removal unit 64 can be, for example, an airflow generator, a water flow generator, an ultrasonic generator, a piezoelectric oscillator or a magnetic force generating element. The external force can be, for example, air flow, water flow, ultrasonic vibration, piezoelectric vibration, suction force or magnetic force. The slag removal unit 64 is not limited to be disposed on the carrier platform 20, and can even be disposed around the electrical discharge section B of the electrode 32. Taking the slag removal unit 64 as an ultrasonic generator or a piezoelectric oscillator as an example, the slag removal unit 64 can be disposed on the jig 36 or the carrier platform 20, for example, and directly acts on the jig 36 or the carrier platform 20 by directly generating an external force. The external force generated by the slag removal unit 64, for example, is capable of also vibrating the jig 36, the to-be-machined object 100 or the electrode 32, vibrating at the same time, for example, to provide an effect of assisting in removal of slag. In addition, as mentioned above, the invention is capable of optionally applying an electrical discharge energy to the machined target area 110 of the to-be-machined object 100 in liquid or gaseous fluids to perform the electrical discharge machining procedure. Taking the above-mentioned liquid or gaseous fluids containing oxygen or ozone as an example, the ultrasonic generator or the piezoelectric oscillator in the slag removal unit 64 of the invention is capable of not only making the carrier platform 20, the to-be-machined object 100 and the electrode 32 vibrate, but also capable of, for example, causing oxygen or ozone in the above-mentioned fluids to generate tiny air bubbles. However, the invention is not limited thereto, and the invention is further capable of, for example, introducing air bubbles containing oxygen or ozone into liquid or gaseous fluids, so that the fluid contains tiny air bubbles. In addition, the invention can also optionally change internal and external pressure differences of the air bubbles by means of the ultrasonic generator, the piezoelectric oscillator, or a flow rate differential pressure of the fluid in order to cause implosion of the air bubbles, which is conducive to performing the electrical discharge machining procedure.

As shown in FIG. 29B, the slag removal unit 64 of the invention is also capable of optionally adjusting applied direction or applied position of an external force according to a shape of the to-be-machined object 100 to eliminate residues generated by an electrical discharge energy applied by the electrode 32 to the to-be-machined object 100. For example, taking the slag removal unit 64 as a water flow generator capable of spraying water to remove residues as an example, the slag removal unit 64 is, for example, provided with a plurality of nozzles 65 capable of shifting positions, and a spraying direction can be adjusted according to a shape of the to-be-machined object 100. For example, if the to-be-machined object 100 is an ingot, multiple nozzles 65 of the slag removal unit 64 are distributed on an arc surface of the ingot, and are optionally distributed on two sides of the arc surface of the ingot. Even, multiple nozzles 65 of the slag removal unit 64, for example, are also capable of optionally adjusting a shape of an arc or positions of the nozzles 65 according to a real-time depth position of electrical discharge machining, thereby achieving an effect of dynamically adjusting water spray according to a shape of the to-be-machined object 100. By the same token, although a water flow generator is used for the slag removal unit 64 as an example, a person having ordinary skill in the art to which the invention pertains should understand how to modify any feasible slag removal unit 64 to achieve an effect of dynamically adjusting water spray or an effect of dynamically adjusting water spray according to a shape of the to-be-machined object 100 in the invention, so it will not be described in detail herein

In other equally feasible embodiments, as shown in FIGS. 29A and 29B, the electrical discharge machining unit 30 of the invention can also, for example, optionally comprise a heat supply source 70 for providing a heat source to the to-be-machined object 100 before, during or after performing the electrical discharge machining procedure by the electrical discharge machining unit 30, thereby the to-be-machined object 100 can be partially (locally) heated or heated as a whole. That is, the heat source provided by the heat supply source 70 is capable of providing energy before and during performing the electrical discharge machining procedure to increase an efficiency of the electrical discharge machining procedure, and also capable of providing repairing, electrical discharge grinding and annealing effects after performing the electrical discharge machining procedure. Wherein the heat supply source 70 can be, for example, either a laser unit, a microwave unit, a radio frequency unit, or an infrared light source, or more than one of the above, by increasing a temperature of the to-be-machined object 100 (such as a solid structure), its material brittleness can be reduced, and a roughness of its cutting or thinning surface can be reduced in order to reduce unnecessary cracks or crack expansion caused by thermal shock. In addition, if the same heat supply source 70 or the different heat supply sources 70 is/are used, by raising a temperature of the to-be-machined object 100, an absorption rate of electromagnetic energy can be increased, thereby forming a positive cycle. For example, taking the heat supply source 70 as a laser unit and a microwave unit as an example, a laser energy provided by the heat supply source 70 (laser unit) is capable of causing the machined target area 110 of the to-be-machined object 100 to generate free electrons, and the free electrons compared with other areas (non-machined target areas) are capable of absorbing more microwave energy provided by the heat supply source 70 (microwave unit), thus increasing a temperature of the machined target area 110, because a temperature rise is conducive to the machined target area 110 absorbing more laser energy to generate more free electrons, and absorbing more electromagnetic energy provided by the microwave unit (such as microwave or radio frequency radiation source), thus forming a positive cycle.

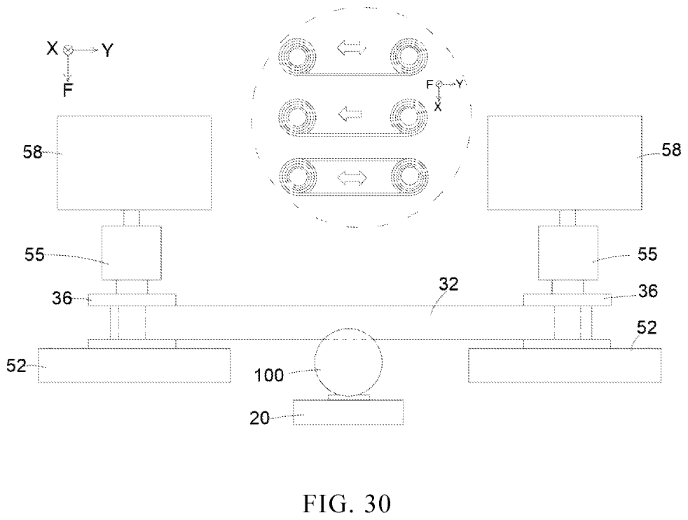

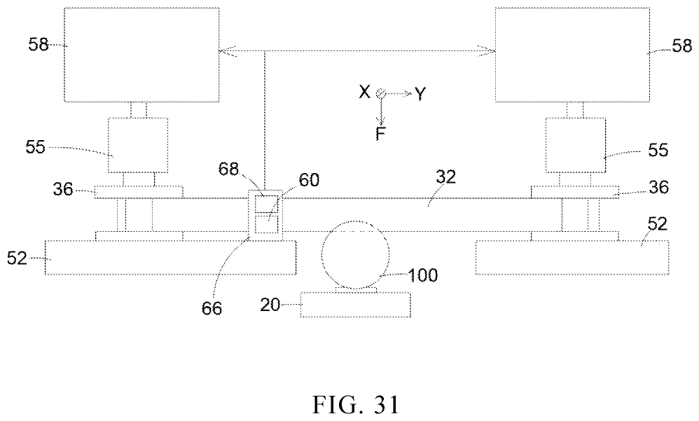

In short, as shown in FIG. 30, the invention uses a variety of ways to make the electrical discharge sections B of the electrodes 32 and the machined target areas 110 of the to-be-machined object 100 move relative to one another along the machining direction F. A first way is that the to-be-machined object 100 moves along the machining direction F and the electrodes 32 are motionlessly fixed in the machining direction F. A second way is that the electrodes 32 move along the machining direction F and the to-be-machined object 100 is motionlessly fixed in the machining direction F. A third way is that the electrodes 32 and the to-be-machined object 100 move along a direction opposite to the machining direction F.

By the same token, the invention further uses a variety of ways to make the electrical discharge sections B of the electrodes 32 and the machined target areas 110 of the to-be-machined object 100 move relative to one another along the second direction Y. A first way is that the to-be-machined object 100 moves along the second direction Y and the electrodes 32 are motionlessly fixed in the second direction Y. A second way is that the electrodes 32 move along the second direction Y and the to-be-machined object 100 is motionlessly fixed in the second direction Y. A third way is that the electrodes 32 and the to-be-machined object 100 move along a direction opposite to the second direction Y. Wherein, in the second way of relatively moving the electrical discharge sections B and the machined target areas 110 along the second direction Y, the invention is also capable of, for example, using the jig 36 to scroll the electrodes 32 in a reciprocating or cyclical manner, so that the electrodes 32 move leftward and rightward (reciprocating manner) or continuously (cyclical manner), or the electrodes 32 are fixed on the jig 36, and the seat body 52 moves the jig 36 leftward and rightward (reciprocating manner) along the second direction Y as shown in the figures in order to move electrodes 32 indirectly.

However, it should be noted that although the invention lists the above-mentioned various moving modes for performing the electrical discharge machining procedure, the moving modes are not intended to limit the invention. For example, a scope of protection claimed by the invention can also cover that the to-be-machined object 100 moves along the machining direction F and the electrodes 32 are motionlessly fixed in the machining direction F and the second direction Y, or the electrodes 32 move along the machining direction F and the to-be-machined object 100 is motionlessly fixed in the machining direction F and the second direction Y. That is to say, any moving mode belongs to a scope of protection claimed by the invention as long as it is capable of carrying out the electrical discharge machining procedure.

In addition, in the invention, a technical means of the jig 36 reciprocatingly or cyclically scrolling the electrode 32 can adopt a mode as shown in FIG. 30 and FIG. 31, wherein the electrode 32, for example, surrounds (double-sided straddle) the two jigs 36 or straddles the two jigs 36 only on one side. The two jigs 36 are rotatably disposed on the seat body 52, and the two jigs 36 are connected to two motors 58 via two couplings 55, so that the two jigs 36 are capable of rotating correspondingly through operation of the two motors 58, and making the electrode 32 move reciprocatingly or cyclically along the second direction Y. Since the electrical discharge section B of the electrode 32 is suspended, the invention optionally has a tension control module 66 (as shown in FIG. 31), which for example comprises the tension measuring unit 60 and a controller 68, wherein the tension measuring unit 60 is used to measure a tension value of the electrode 32, and the controller 68 is electrically connected to the two motors 58 in order to control the two motors 58 according to a tension value of the electrode 32, so that the two motors 58 decrease or increase in rotation speed at a same speed to adjust a tension value of the electrode 32, thereby making the electrode 32 maintain a specified tension value when moving along the second direction Y. In addition, the invention is capable of further calculating a time for the two motors 58 to switch operation directions according to a length and a moving speed of the electrode 32 to achieve an effect of making the electrode 32 reciprocate.

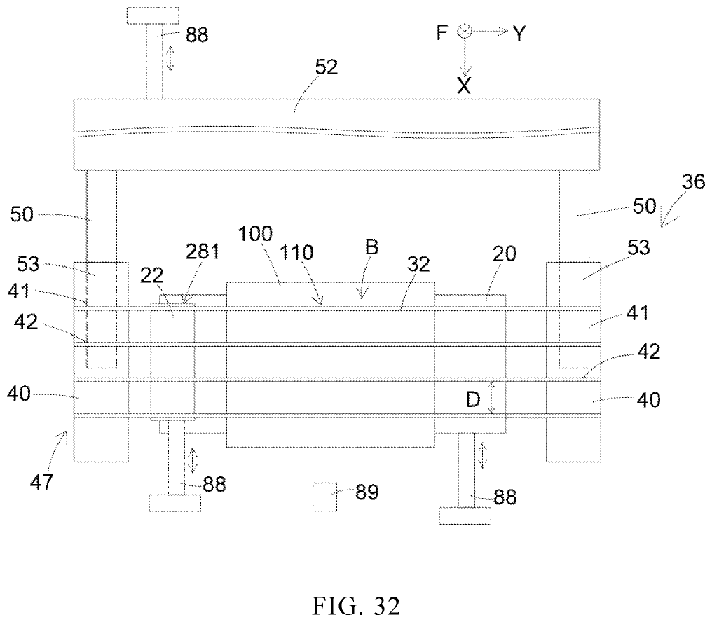

As shown in an implementation mode in FIG. 32, the electrical discharge machining apparatus 10 of the invention can optionally further comprise an orientation correction element 88 used for adjusting relative orientations of the electrode 32 and to-be-machined object 100 according to a deviation phenomenon when deviations occur in the machining direction F of the electrode 32 such as skewed in order to correct the machining direction F of the electrode 32 and the to-be-machined object 100. For example, the orientation correction element 88 can be, for example, a retractable push rod (such as a manual or an electric retractable push rod), for example, by pushing the carrier platform 20, the electrode 32 or other components in the electrical discharge machining apparatus 10 that can change relative orientations of the electrode 32 or the to-be-machined object 100 to achieve, for example, an effect of correspondingly adjusting relative orientations of the electrode 32 and the to-be-machined object 100 along the first direction X. For example, the invention is capable of knowing in real time whether the machining direction F of the electrode 32 deviates, for example, through a detection element 89. Wherein the detection element 89 is, for example, an electrical discharge change detection element, or a photoelectric detection element or an image detection element provided with a light emitter and a light receiver, and is used to know whether the machining direction F of the electrode 32 is deviated through light interruption or light intensity change.

In summary, the electrical discharge machining apparatus according to the invention has the following advantages:

(1) The jig is formed by correspondingly assembling the at least two carrying members and the at least two holding members respectively, a quick-release design is capable of greatly reducing a time required for electrode replacement, and is also capable of adjusting a tension of the electrical discharge electrode.

(2) A slag removal unit is capable of providing an external force for one machined target area or more than one machined target areas, and an applied direction or an applied position of the external force is dynamically adjusted according to changes of a shape of the to-be-machined object to help eliminate residues generated by the electrical discharge machining procedure.

(3) A clamping element has a variety of clamping modes, a comb-like structure is capable of firmly clamping the to-be-machined object, which can effectively solve the problem that the conventional electrical discharge machining apparatus technology is incapable of cutting an overlapping area between the clamping element and the to-be-machined object, and a lock-in structure is further capable of achieving efficacies of disassembly and adjustment.

(4) An orientation correction element is capable of correcting the machining direction of the electrode and the to-be-machined object, thereby avoiding deviation of the machining direction.

(5) The comb-like structure formed by the clamping element or the carrier platform is conducive to the electrical discharge machining procedure and correspondingly avoiding damage.

(6) A stabilizing member is capable of reducing chattering of the electrode, serving as a separation column to provide a guiding effect, and serving as an electrical contact.

(7) A heat source is capable of reducing unwanted cracks or crack expansion caused by thermal shock, and further capable of forming a positive cycle to facilitate the electrical discharge machining procedure.

(8) A conductive gain layer is capable of improving an electrical contact between the to-be-machined object and the clamping element or the carrier platform.

(9) An adhesive layer is capable of avoiding chattering phenomenon of the to-be-machined object during the electrical discharge machining procedure, and avoiding burr phenomenon before an end of the electrical discharge machining procedure, and a conductive adhesive layer is further capable of providing an electrical contact between the to-be-machined object and the clamping element or the carrier platform.

Note that the specification relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An electrical discharge machining apparatus at least comprising:
a carrier platform for carrying at least one to-be-machined object; and
an electrical discharge machining unit for performing an electrical discharge machining procedure on a machined target area of the to-be-machined object on the carrier platform along a machining direction, the electrical discharge machining unit comprising:
at least one electrode;
a jig, the jig being formed by correspondingly assembling at least two carrying members and at least two holding members respectively, two sides of the electrode abutting against the two carrying members respectively, so that an electrical discharge section of the electrode being suspended, wherein the electrical discharge section of the electrode extends along a second direction perpendicular to a first direction; and
a power supply unit, the power supply unit providing a first power source to the electrode and the to-be-machined object in the electrical discharge machining procedure for applying an electrical discharge energy to the machined target area of the to-be-machined object through the electrical discharge section of the electrode, wherein when the electrical discharge machining unit performs the electrical discharge machining procedure along the machining direction, the electrical discharge section of the electrode and the machined target area of the to-be-machined object move relatively along the second direction.

2. The electrical discharge machining apparatus as claimed in claim 1, wherein the electrical discharge section of the electrode and the machined target area of the to-be-machined object move relative to each other along the second direction in a reciprocating or cyclical manner.

3. The electrical discharge machining apparatus as claimed in claim 2, wherein the two carrying members and the two holding members move reciprocatingly or cyclically with the electrode, so that the electrical discharge section of the electrode applies the electrical discharge energy to the to-be-machined object.

4. The electrical discharge machining apparatus as claimed in claim 1, wherein the electrical discharge machining unit adjusts a tension value of the electrode by causing relative displacements of the two carrying members or the two holding members.

5. The electrical discharge machining apparatus as claimed in claim 2, further comprising a stabilizing member for stabilizing a movement of the electrode relative to the to-be-machined object.

6. The electrical discharge machining apparatus as claimed in claim 1, wherein the electrode is in a linear shape or in a plate shape.

7. The electrical discharge machining apparatus as claimed in claim 1, wherein the carrier platform moves along the first direction, the second direction, or the machining direction.

8. The electrical discharge machining apparatus as claimed in claim 1, wherein the carrier platform rotates around the first direction, the second direction or the machining direction as an axis.

9. The electrical discharge machining apparatus as claimed in claim 1, further comprising a slag removal unit, when the electrical discharge machining unit performs the electrical discharge machining procedure on the to-be-machined object, the slag removal unit provides an external force to remove residues generated by the electrical discharge energy applied by the electrode to the to-be-machined object.

10. The electrical discharge machining apparatus as claimed in claim 9, wherein an applied direction or an applied position of the external force provided by the slag removal unit is dynamically adjusted to remove residues according to a shape of the to-be-machined object.

11. The electrical discharge machining apparatus as claimed in claim 1, further comprising a tension measuring unit for measuring a tension value of the electrode.

12. The electrical discharge machining apparatus as claimed in claim 1, further comprising a vibration measuring unit for measuring a vibration value of the electrode.

13. The electrical discharge machining apparatus as claimed in claim 1, wherein the power supply unit of the electrical discharge machining unit further provides a second power source to the electrode in order to provide a direct-current power supply or a radio frequency to the electrode.

14. The electrical discharge machining apparatus as claimed in claim 1, wherein the carrier platform further comprises a clamping element for fixing the to-be-machined object.

15. The electrical discharge machining apparatus as claimed in claim 14, wherein the to-be-machined object has a planar area, and is connected to the carrier platform or the clamping element through the planar area.

16. The electrical discharge machining apparatus as claimed in claim 14, wherein a shape of the clamping element is attached along a shape of the to-be-machined object.

17. The electrical discharge machining apparatus as claimed in claim 14, wherein the clamping element has a plate body, and the plate body has a comb-like structure.

18. The electrical discharge machining apparatus as claimed in claim 1, wherein the carrier platform has a comb-like structure.

19. The electrical discharge machining apparatus as claimed in claim 14, wherein the carrier platform is connected to the clamping element through a lock-in structure.

20. The electrical discharge machining apparatus as claimed in claim 14, wherein two plate bodies of the clamping element are connected to each other through a snap-fit structure.

21. The electrical discharge machining apparatus as claimed in claim 14, wherein the clamping element has two or more than two contact surfaces with the to-be-machined object.

22. The electrical discharge machining apparatus as claimed in claim 14, wherein the carrier platform or the clamping element is connected to the to-be-machined object by an adhesive layer.

23. The electrical discharge machining apparatus as claimed in claim 22, wherein the adhesive layer is discontinuously disposed on the carrier platform or the clamping element.

24. The electrical discharge machining apparatus as claimed in claim 22, wherein the adhesive layer is a conductive adhesive.

25. The electrical discharge machining apparatus as claimed in claim 14, wherein the clamping element axially abuts against one side of the to-be-machined object, and two groove walls of a machining groove formed by the electrical discharge energy in the machined target area of the to-be-machined object are bonded by an adhesive layer.

26. The electrical discharge machining apparatus as claimed in claim 14, wherein the electrical discharge machining unit performs the electrical discharge machining procedure on the to-be-machined object on the carrier platform and the clamping element along the machining direction.

27. The electrical discharge machining apparatus as claimed in claim 14, wherein the clamping element clamps a buffer member, the buffer member fixes the to-be-machined object through a conductive adhesive layer, and the electrical discharge machining unit performs the electrical discharge machining procedure on the to-be-machined object on the carrier platform along the machining direction.

28. The electrical discharge machining apparatus as claimed in claim 14, wherein the clamping element fixes the to-be-machined object by clamping a conductive frame, and the electrical discharge machining unit performs the electrical discharge machining procedure on the to-be-machined object on the carrier platform along the machining direction.

29. The electrical discharge machining apparatus as claimed in claim 14, wherein the carrier platform, the clamping element or the to-be-machined object further has a conductive gain layer to improve an electrical contact between the to-be-machined object and the carrier platform or the to-be-machined object and the clamping element.

30. The electrical discharge machining apparatus as claimed in claim 1, further comprising a heat supply source for providing a heat source to the to-be-machined object before, during or after performing the electrical discharge machining procedure.

31. The electrical discharge machining apparatus as claimed in claim 1, wherein the two carrying members are respectively a plate structure or a sleeve structure.

32. The electrical discharge machining apparatus as claimed in claim 1, wherein the two carrying members respectively comprise a first sheet and a second sheet, and the electrode is clamped between the first sheet and the second sheet.

33. The electrical discharge machining apparatus as claimed in claim 1, wherein the two carrying members respectively have a through groove, the two holding members respectively have a protrusion corresponding to the through groove, and the two carrying members are assembled with the protrusions of the two holding members correspondingly through the through grooves.

34. The electrical discharge machining apparatus as claimed in claim 1, wherein the two carrying members respectively have a through hole, the two holding members respectively have a screw hole, wherein the two carrying members are screwed with the screw holes of the two holding members by passing a bolt through each of the through holes.

35. The electrical discharge machining apparatus as claimed in claim 1, wherein the two holding members respectively have a groove structure, and the two carrying members are inserted into the groove structures of the two holding members to be correspondingly assembled on the two holding members.

36. The electrical discharge machining apparatus as claimed in claim 1, wherein the two holding members respectively have a conductive structure to electrically connect with the electrode abutting against the two carrying members.

37. The electrical discharge machining apparatus as claimed in claim 1, wherein the two holding members fix the two carrying members and the electrode simultaneously.

38. The electrical discharge machining apparatus as claimed in claim 1, wherein the electrical discharge machining unit further comprises an attachment member, and attachment member is connected to the electrode at an edge of the two carrying members.

39. The electrical discharge machining apparatus as claimed in claim 38, wherein the attachment member is electrically connected to the first power source or a second power source of the power supply unit.

40. The electrical discharge machining apparatus as claimed in claim 1, wherein head and tail ends of the electrode are respectively connected to the same carrying member or the two carrying members.

41. The electrical discharge machining apparatus as claimed in claim 1, wherein edges of the two carrying members have lead angles.

42. The electrical discharge machining apparatus as claimed in claim 1, wherein the to-be-machined object carried by the carrier platform is a semiconductor ingot or wafer.

43. The electrical discharge machining apparatus as claimed in claim 1, wherein the electrical discharge machining apparatus cuts or grinds the to-be-machined object carried by the carrier platform sequentially or simultaneously during the electrical discharge machining procedure.

44. The electrical discharge machining apparatus as claimed in claim 1, wherein the to-be-machined object is formed by electrically bonding a plurality of workpieces.

45. The electrical discharge machining apparatus as claimed in claim 1, wherein the electrical discharge energy forms a machining groove in the machined target area of the to-be-machined object, and a filling material is filled in the machining groove.

46. The electrical discharge machining apparatus as claimed in claim 1, wherein the electrical discharge energy forms a machining groove in the machined target area of the to-be-machined object, and the to-be-machined object is pasted with an adhesive tape on two sides of the machining groove to reduce a chattering phenomenon of the machined target area of the to-be-machined object.

47. The electrical discharge machining apparatus as claimed in claim 1, wherein the electrical discharge machining procedure applies the electrical discharge energy to the machined target area of the to-be-machined object in a fluid.

48. The electrical discharge machining apparatus as claimed in claim 47, wherein the fluid contains ozone or oxygen.

49. The electrical discharge machining apparatus as claimed in claim 47, wherein the fluid contains air bubbles.

50. The electrical discharge machining apparatus as claimed in claim 49, wherein the air bubbles are imploded by an internal and external pressure difference during the electrical discharge machining procedure.

51. The electrical discharge machining apparatus as claimed in claim 49, wherein the air bubbles contain ozone or oxygen.

52. The electrical discharge machining apparatus as claimed in claim 47, wherein the fluid is an electrolyte.

53. The electrical discharge machining apparatus as claimed in claim 1, wherein the electrical discharge machining procedure applies the electrical discharge energy to the machined target area of the to-be-machined object in a vacuum environment.

54. The electrical discharge machining apparatus as claimed in claim 1, further comprising an ultrasonic generator or a piezoelectric oscillator to vibrate the carrier platform, the to-be-machined object or the electrode.

55. The electrical discharge machining apparatus as claimed in claim 47, further comprising an ultrasonic generator or a piezoelectric oscillator to vibrate the carrier platform, the to-be-machined object, the electrode or the fluid.

56. The electrical discharge machining apparatus as claimed in claim 1, wherein a quantity of the electrode is multiple, and the electrodes are arranged in parallel along the first direction.

57. The electrical discharge machining apparatus as claimed in claim 1, further comprising an orientation correction element for adjusting a relative orientation of the electrode and the to-be-machined object to correct the machining direction when a deviation phenomenon occurring in the machining direction of the electrode.
